(19) United States
(12) Patent Application Publication
(10) Pub. No.: US 2014/0172557 A1
(43) Pub. Date: Jun. 19, 2014

(54) INTERACTIVE DISPLAY SYSTEM

(71) Applicant: FootTrafficeker LLC, Chicago, IL (US)

(72) Inventors: Avinoam Eden, Hinsdale, IL (US); Randall Horton, Deerfield, IL (US); Joseph Born, Lincolnwood, IL (US); Seth E. Bennett, Chicago, IL (US); David Eschbaugh, Chicago, IL (US); James Ondrey, Chicago, IL (US); Steven Mitchell, Iowa City, IA (US)

(21) Appl. No.: 14/107,741

(22) Filed: Dec. 16, 2013

Related U.S. Application Data
(60) Provisional application No. 61/739,190, filed on Dec. 19, 2012.
(60) Provisional application No. 61/779,922, filed on Mar. 13, 2013.

(51) Int. Cl. G06Q 30/02

(52) U.S. Cl. CPC G06Q 30/0251
USPC 705/14.49

(57) ABSTRACT

A computerized interactive display system configured to function through a window such as a window of a storefront and to be fully interactive with a person standing on an exterior side of the window.

### PRIORITY CLAIM

This application is a non-provisional of and claims the benefit of and priority to U.S. Provisional Patent Application No. 61/739,190, filed Dec. 19, 2012, and U.S. Provisional Patent Application No. 61/779,922, filed Mar. 13, 2013, the entire contents of which are incorporated herein by reference.

### COPYRIGHT NOTICE

A portion of the disclosure of this patent document contains material which is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### BACKGROUND

Virtually every business continually seeks new and different ways to enhance both the quantity and quality of their customer relationships. This is an increasingly challenging proposition since there is continually more and more competition for both people's attention and money.

One such type of business is a store that sells products and that is adjacent to one or more streets. Such stores: (a) exist throughout the United States and the rest of the world; (b) typically take up part or all of the interior spaces of a building; (c) operate in those interior spaces of the building; and (d) typically have one or more storefronts adjacent to one or more of the streets. Storefronts typically include one or more doors that provide access into the stores and one or more windows that enable people on the streets on the outside of the stores to look into the stores. For purposes of this application, the term street is meant to include the road and sidewalks of a street. Additionally, for purposes of this application, the term street is meant to include the walkways in a mall (which are on the outside of the stores).

Stores often place displays in the interior spaces adjacent to their storefronts to display merchandise. These displays are often called storefront displays. Stores typically use storefront displays to show various store products or merchandise to people who pass by the stores on the streets. Various goals of showing these products or merchandise is to entice people passing by the stores to stop and look at these storefront displays, to enter the stores, and to possibly make purchases in the stores. Another goal is to generally raise awareness with the people on the street about the store and its products and services, so that the people may choose to return at a later date. This is particularly relevant if a person's first interaction with the store window occurs at a time when the store is closed (e.g., evenings, weekends, and holidays). Further goals are to induce the people to engage with another physical location of that store (e.g., a retail chain) or engage with the store through one of their other store channels (e.g., online or through a mail order catalog). In one sense, the storefront and storefront displays tend to act as gateways between the inside of the store and the outside of the store. Thus, one significant advantage that a store (such as a retail store) has over other types of competitors (e.g., online-only competitors) is its physical proximity to people passing by on foot, on a bicycle, in a vehicle, or using other forms of transportation, or alternatively passing by a walkway in a mall or other indoor retail setting.

These storefront doors and windows also provide significant additional benefits to the store operators such as: (a) providing a certain level of physical security or protection for the products, displays, and equipment inside of the stores; (b) protecting the interior of the stores from weather and enabling the control of temperature inside of the stores; and (c) providing a space for a limited amount of advertising to people passing by the doors and windows.

These storefront doors and windows also create certain challenges for store operators such as: (a) by creating a physical barrier between people passing by or near their store and the employees, goods, and services accessible or available within the store (as opposed to open type markets); and (b) by only providing a one-way (i.e., display) medium for advertising rather than a two-way medium for interactivity with the people passing by the store. In other words, known storefronts and display windows facilitate commerce by generally using one-directional advertising as their main way of communicating with people passing the display windows, as opposed to facilitating two-way engagement with people on the street.

Various solutions to these challengers have been employed by stores (such as retail stores). For example, various stores have printed paper advertisements and have hired people to stand on the street(s) adjacent to the stores to hand these advertisements out to people. Various stores have hired people to dress in costumes and stand on the street(s) adjacent to the stores to hold signs relating to the stores or otherwise to attract attention to the stores. Various stores have placed analog and digital displays and signage in the interior spaces adjacent to the storefronts to attract people to or pull people from the street into the stores.

While these various solutions have in part been successful to solve certain of the above mentioned limitations, store operators are continually searching for new and better methods of increasing store revenue by: (a) gaining the attention of people passing by their stores and ultimately drawing them into the stores (i.e., store operators are continually trying to convert street traffic into store visitors); (b) developing strong two-way interactions and relationships with their customers and potential customers that transcend a single transaction into an affinity for the stores and the products, services, and brands provided by the stores; and (c) collecting actionable data that enables stores to gain insights into customer or potential customer behavior and iteratively modify their practices to improve key metrics involved in converting street traffic into store visitors and active customers.

Various other types of business have similar problems with storefronts and interacting with people who pass by on the streets. For example, restaurants and bars that are adjacent to streets also typically take up part or all of a building and include an interior space in the building in which the restaurant operates and one or more storefronts adjacent to one or more streets. Other examples include service business (such as real estate brokerages, beauty salons and spas, dentist, doctor and chiropractor offices, government offices offering services to the public, banks and other consumer financial services organizations, and theaters and other live entertainment venues) which are adjacent to streets and also typically take up part or all of a building and include an interior space in the building in which the service business operates and one or more storefronts adjacent to one or more streets.

These restaurants, service business, and other organizations with storefronts also have not fully maximized or fully leveraged the storefront displays and display windows as tools for interactive customer communication which lead to new revenue streams. This is problematic due to the sheer number of storefronts and display windows located throughout the United States and the world. This is also problematic because many of the display windows are much larger in size than other communications mediums (such as paper advertisements or banner advertisements on websites), creating an opportunity for better utilization of large windows.

These stores, restaurants, service business, and other organizations with storefronts have also not fully maximized or fully leveraged the attraction multiplier effect that storefronts, display windows, and storefront displays can provide. If such organizations are better able use their storefronts, display windows, and storefront displays to attract passersby and retain their attention for any significant periods of time, those people who have stopped will tend to attract more people to the storefronts, the display windows, and storefront displays (i.e., creating a viral multiplying effect). In other words, people are often driven to look at things that other people are already looking at, on the premise that if someone else is giving it attention, it must be worth their own attention. Therefore, the ability to attract people to storefronts, display windows, and storefront displays can ultimately provide additional benefits from a large multiplier effect.

As mentioned above, while stores, restaurants, service business, and other organizations with storefronts have placed displays such as televisions, kiosks, and computer displays in the interior spaces of their businesses adjacent to the windows, fully interactive computers have not been blended with storefront or other windows on any large scale for a variety of different reasons. These reasons include, but are not limited to: (a) potential issues of intentional, accidental, or weather-related damage; (b) potential theft of any components outside of the interior space; (c) a lack of an easy to install and operate, cost-effective technology that provides full interactivity literally through the full range of windows and doors of storefronts that exist throughout the United States and the rest of the world; (d) the inability of existing capacitive screen technologies (such as touch foil technologies) to work through a window that is configured for energy efficiency by encasing a gas (such as argon) between the windows panes (such as a 1 inch thick, double paned window); and (e) the inability of existing gesture based technologies (such as the Kinect and Leap Motion) to work through a window that is configured for energy efficiency by encasing a gas (such as argon) between the windows panes (such as a 1 inch thick, double paned window) or a tinted window.

Another related existing problem for businesses adjacent to streets is the inability to accurately monitor activity on the streets and relating that activity to in-store activity. Various businesses have a need to monitor activities occurring outside of their interior spaces, as well as to communicate with people on the streets adjacent to their businesses. This includes: (a) organizations that need to monitor street activity for security purposes (e.g., using video cameras); (b) organizations that wish to get a better understanding of the activity occurring on the adjacent streets in terms of type of activity (e.g., such as foot vs. bicycle vs. stroller vs. automobile activity); (c) organizations that wish to get a better understanding of the times (including season, month, hour/minute, special events such as holidays and weather conditions) when these activities take place; and (d) organizations that wish to identify slowdowns in street traffic due to factors such as street congestion or roadwork so that they can share this traffic information with others. This data is useful in gaining insights that enable businesses to improve the conduct of their business in that specific physical location. This data is also useful to other business not physically located on the street such as organizations that aggregate and monetize real-time automobile traffic congestion data and government entities seeking to monitor traffic volumes and speeds at specific locations.

Currently, the solutions for solving the above activity monitoring related problems typically require the physical installation of purpose-built equipment such as security cameras which generally do not provide any other functionality, and do not provide the ability to communicate interactively with people on the streets (e.g., to produce a voice that loudly announces “You are being watched and recorded right now” in the event that a user appears to be loitering in front of a specific location for a long period of time).

Additionally, various organizations also lack an ability to gain insights into the relationships between activity on the adjacent streets and activity inside their spaces or buildings. For example, organizations engaged in ecommerce can now utilize a fairly comprehensive set of quantitative tools to identify the baseline metrics related for user demographics and behaviors related to ecommerce, adjust their activities accordingly to try to improve key metrics, and then quantify the impact of their adjustments to the baseline. In contrast, the level of metrics development and use that are now available for ecommerce are much harder to achieve in brick and mortar settings despite the efforts of multiple companies working on solutions to this problem. For example, many store operators do not have a sophisticated, quantified understanding of what is often referred to as the sales funnel, since like a funnel it involves a process of moving people from the top of the funnel (being a prospect) to the bottom of the funnel (being a customer). The funnel can include the basic steps of moving people from being potential customers not aware of a product/service to being aware of the product/service to someone considering buying that product/service to having actually bought that product/service. In the context of a retail store, a funnel could include the following types of metrics tracking: (a) the number and types of people passing by a store; (b) the percentage of people that stop in front of the storefront display or store window to look at or into their store; (c) the percentage of people that enter the store; and (d) the percentage of people that buy something at the store. If organizations had an ability to track these types of metrics, then they would be empowered to use this data to test different methods of converting foot traffic into store sales, and to find and scale-up the methods that are the most effective.

Another well know problem is the ever growing need to provide people with fast, readily accessible, powerful, and pervasive computing in outdoor settings or locations. Over the last several years, consumers have demonstrated a continuing desire to utilize networked computers in almost every facet of their lives. Mobile computing solutions such as laptops, tablets, and smart phones that enable consumers to access the internet for communication, entertainment (such as gaming), productivity, and work are carried by an ever increasing percentage of the United States and world population. Networked computer functionality is now being embedded into a wide range of consumer-facing devices and machines including consumer electronics such as video game players, automobiles, and home appliances (such as televisions). Consumers are also making use of computing devices that are available to the general public. For example, public desktop computers with internet access are available for customers at hotels and for the general public at many public libraries. More specialized kiosk computers are also now available to the general public at public venues such as entertainment centers and airports. Additionally, Wi-Fi access is now available in many settings or locations (for free or for a relatively small fee) to the general public and wireless broadband access is now available to paying consumers to provide on-demand internet access for mobile devices.

However, there are still various crucial limitations for consumers on the accessibility of computers in many of these out-of-the-home or out-of-the-business settings or locations. For example, there is an inverse relationship and tradeoff between the portability of a mobile device and the size of the display that the mobile device is able to offer (i.e., that is, the smaller and more portable the computer, the more restricted the user is in terms of the size of the screen that they interact with, thereby limiting the computing experience). A similar inverse relationship exists between the size, weight and cost of the mobile device on the one hand and the processing power of the device on the other hand. The number of publicly available desktop computers and kiosks are currently are also limited to a select groups of public venues. Additionally, the placement of these computers and kiosks is typically limited to indoor locations where they are not exposed to theft, malicious damage, or harm from weather elements (such as extreme heat, extreme cold, rain, snow, or ice). For example, tablet computers intended for use by retail shoppers in stores are often installed near a cash register, where they can be observed by a store employee. Belly is one such example that can be installed on a table computer such as an iPad installed next to a cash register. In other examples, touch screen kiosks are often not installed outdoors where rain, snow, and ice can damage them. Since high-speed internet access through mobile networks is still constrained in terms of geographic coverage, localized limitations due to physical impediments such as building walls and a relatively high cost, users are still often dependent on a nationwide patchwork of free and licensed Wi-Fi networks.

Another growing problem is the ever increasing availability of hundreds of thousands of applications on mobile devices and the need to download and install them on an individual basis, even if the customer wishes to only use the application a single time or rarely. This large number of applications is leading to application fatigue problems and mobile device storage constraints which are in turn preventing or inhibiting people from downloading individual applications for every store, retailer, restaurant, service business, or other organization that they wish to interact with.

Certain known solutions to these problems include various technologies and devices that enable a window to be turned into a surface for a computer input. These known solutions have been applied to retail store windows. However, these known solutions have not been widely implemented in part because they have significant problems, and in particular such computing devices: (a) cannot work on thick or multi-paned windows (such as a 1 inch thick double paned windows); (b) cannot work on windows with certain film and tinting treatments; (c) lose resolution as the window mechanics become more complex; (d) are fairly expensive (such as more than $1000 for relatively small surfaces); (e) require significant design, software, hardware, content and mechanical development efforts to create even a single specific software application (let alone multiple software applications); (f) require the skills of a trained technician to properly install; and (g) do not create a network event where all of the individual installations can exchange data thereby adding more value for both the users and the stores.

More specifically, there are a number of companies who have developed touchscreen window technologies that use capacitive technologies to enable a user on the outside of a window to interact with a capacitive input device mounted on the inside of the window. An image is displayed through a monitor adjacent to the window or by projecting an image using the capacitive technology. Companies that have developed this type of technology include: (a) Zytronic's Zyfilm technology in the United Kingdom; (b) Screen Solutions International (SSI)'s Touch Foil technology in California: (c) PMI Technologies' ProDisplay Rear Projection Foil (Holographic Touch Foil) technology in China; (d) Vislogix's EZtouch Window technology in Florida; (e) DISPLAX Interactive Systems' Skin Multi-touch and Arena technologies in Portugal; (f) Prodisplay's technologies in the United Kingdom; and (g) Bash Interactive's iGlass technology in Canada.

The above listed capacitive window technologies all share a number of common, significant limitations that hinder a large scale adoption for use in storefronts or retail windows. These products are all fairly expensive, with the smallest sizes for the capacitive technologies starting around $2000 (U.S. Dollars). Further, this cost is generally just for the touchscreens and not the displays that are required for an interactive experience. This cost is even higher for those technologies which require a trained technician to perform the installation.

Another significant limitation is that the current U.S. standard for energy efficient commercial windows is a one inch thick, double paned window with argon gas sealed in the window between the panes. Only a few of these products claim that they will work with that type of window. Further, even those products that can work with that type of window caution that their technology may not work in the event that the window has certain types of treatments or is surrounded by an element such as silver.

A further major limitation is that these technologies are simply configured to support display and data input. They do not provide any further functionality than that, meaning that any organization that wishes to use the technology has to create and develop the software, databases and related hardware to provide specific applications.

Taking a different approach to capacitive touch screen technologies, Touch Point Systems in Michigan has developed a touch screen through glass solution that is specifically for real estate companies to display real estate listings. One limitation of this system is that it is configured in terms of hardware and software to only support a single application in a single industry in a stand-alone manner. Another limitation is that this system costs over $15,000 (U.S. Dollars).

InWindow Outdoor in New York has developed touch screen and gesture-based customized solutions that are configured to work through windows. However, it appears that every customer implementation requires a new development project and these solutions are not configured to be cost-affordable to any business.

A number of companies have also developed technologies that include cameras installed on the inside and outside of stores. The cameras record videos of shoppers and then process the videos through algorithms configured to count the number of shoppers and track their specific movements to provide insights. Examples of this are ShopperTrak in Chicago and MotionLoft in San Francisco. The major drawback to these systems is that they do not directly engage with the shoppers that they are tracking. This makes it more difficult to uniquely identify the shopper on the video and then tie that person to the same shopper's records in other store systems such as the point of sale systems or customer relationship management systems. The lack of interactivity also greatly limits the potential value of these solutions to just one domain, tracking shoppers by video for analytics.

There are also solutions that exist to detect the nearby presence of mobile devices carried by users (such as smartphones and tablets) using WiFi and/or Bluetooth and then to uniquely identify each device such as Nomi. These solutions are used for analytics to better understand customers (and potential customers) and their behaviors. One of the limitations of these solutions is that they do not come bundled with functionality to leverage this data to create real-time interactive experiences with users.

Accordingly, the known systems and technologies do not solve the above problems and there is a continuing need to solve these various described problems.

### SUMMARY

Various embodiments of the present disclosure address the above problems by providing a computerized interactive display system configured to function through a window of a storefront and to be fully interactive with a person standing on an exterior side of the window of the storefront. The remainder of this document refers to this person as the user. The computerized interactive display system of the present disclosure is configured to work with any suitable window such as a transparent or translucent window made from glass, plastic, or another material, windows that are multi-paned with a gas element (such as argon) contained between the panes, windows treated with various films and tinting used for energy efficiency and aesthetics and windows that are relatively thick (such as 1 inch thick windows). The computerized interactive display system of the present disclosure is also configured to function through other transparent or translucent objects (i.e., other than windows) made from glass, plastic, or other materials. The computerized interactive display system of the present disclosure is configured to function on a continuous basis (such as 24 hours a day, seven days a week, and 365 days a year) even during times when the store is closed. For brevity, the computerized interactive display system of the present disclosure may sometimes be referred to herein as the computerized system, the interactive display system, the interactive system, the display system, or simply the system.

In this disclosure, the term system is meant to include either: (a) the designated components at the store or storefront including the local computer(s) and other designated components; or (b) the designated components at the store or storefront including the local computer(s) and other designated components as well as the designated remote computer(s).

Various embodiments of the computerized interactive display system are also configured to expose no components or minimum components to theft, malicious damage, or harm from weather elements. More specifically, in certain embodiments of the system, the system includes no components on the exterior side or outside of the window. In other embodiments, the system includes a minimum number of components and specifically no electronic components on the exterior side or outside of the window.

Various embodiments of the computerized interactive display system of the present disclosure generally include: (a) one or more local computers; (b) one or more display devices controlled by the local computer(s) and configured to be positioned adjacent to an interior surface of a window; (c) one or more audio production devices positioned adjacent to an interior surface of the window or positioned on the exterior of the window; (d) one or more user input devices mountable on an exterior or interior surface of the window; (e) one or more user input detectors positioned adjacent to an interior surface of the window, configured to detect or capture and record user inputs made using the user input device(s), and configured to communicate with the local computer; (f) one or more components that can detect and uniquely identify mobile devices being carried by users in the immediate vicinity; (g) one or more component supporting devices configured to hold the local computer(s), the display device(s), and the user input detector(s) relative to the interior surface of the window; (h) one or more applications that can be installed on the local computer to provide different sets of functionality depending on the unique needs of each store and its users; and (i) one or more Application Programming Interfaces (APIs) that provide access to common functionality and data to all of the applications. These local computer(s), display device(s), user input device(s), and user input detector(s) co-act to enable a person on the exterior side of the window to see the displays by the display devices and/or hear audio produced by the sound production devices and to make inputs into the system through the window.

In various embodiments, additional components of the system are installed in remote data centers and accessed by the local computer over a suitable data network such as the Internet. These components include one or more remote computers which have both databases and application software. By accessing these remote data centers, as well as other resources available on the Internet, and by being able to aggregate data from all of the local computer instances, the functionality of the system available to stores and users is greatly extended.

In various embodiments, the system enables users such as people passing by the window to provide or input data into the system through a plurality of different devices such as: (a) microphones; (b) cameras; (c) keyboards; and (d) touch pads, from the exterior side of the window to use and interact with the rest of the system on the interior side of the window. While enabling this use, the system protects the various components of the system such as the local computers, display screens/projectors/laser-based signs, video/still digital cameras, external lighting/backlighting devices, microphones, speakers, and other devices by positioning such devices on the interior side of the window (which the user cannot physically access from outside of the window).

It should be appreciated that the system of the present disclosure can be installed anywhere that an interactive experience can take place between an organization or business and current or potential customers, referrers of business, or users. This includes, but is not limited to: (a) windows on retail or wholesale stores; (b) restaurants and bars; (c) healthcare provider offices; (d) real estate brokerages; (e) empty buildings or building spaces for sale or rent; (f) buildings or building spaces that have been sold or rented and a new business is being built out; (g) display windows built into bus stop shelters; (h) ticketing windows (such as at public event venues; (i) stand-alone display windows; (j) ordering stations that are placed before a user in a car pulls up to a drive through window; and (k) at gas station pumps.

The system provides a user experience with increased and more efficient contacts (including contacts with the store operators), better overall communication (including better communication with the store operators), better monetization of real estate investments, and stronger relationships between users on foot and operators of the system (including retailers, non-retail organizations, and advertisers).

It should be appreciated that in various embodiments, the system has a set of general functionality, applications, and content that work in a default mode. The default mode will operate with the same settings regardless of the window and type of location in which the system is installed. Additionally, various embodiments of the system include multiple levels. For example, a first level of functionality, applications, and content can be implemented for a specific installation of the system configuring the system for a particular type of establishment (such as restaurant, retail bank, or clothing store), as well as the geographic coordinates of the installed system. A second level of functionality, applications, and content can be implemented when the street traffic camera detects a particular type of person walking past the window (such as a person pushing a stroller or a person walking a dog) where the system is installed. A third level of functionality, applications, and content can be implemented when the street traffic camera detects a person and is able to match the person's face to a photograph of a person already in the system's user database. In this third level of functionality, the system may also detect a person through the Mobile Device Detector. A fourth level of functionality, applications, and content can be implemented when a user authenticates with the system (for example, with some form of a username and password) installed on the window through one of the authentication methods described later in this document. Each successive level of personalization will enable the system to provide functionality, applications, and content that is better tailored to the individual needs and desires of the user. However, it should be appreciated that the system is configured to enable users to use the system without being identified. The system will enable such users, for example, to learn more about the products and/or services provided by the store.

The system provides users with a rich interactive experience that is currently unavailable to users on the street who are generally limited to smart phones and tablets which require separate application downloads for each activity that they support. Further, these smart phones and tablets are limited by far smaller screen sizes than provided by the system of the present disclosure. Further, since these mobile devices belong to the user and not to the landlord or store owner or operator, the user must elect to receive content and functionality from that venue on their device (e.g., such as by going to a website or downloading an application). Further, by turning windows into devices for interactive user experiences, the system provides unique user experiences which enable organizations and businesses engaged in commerce and other types of communications activities to better bridge gaps between the physical world (including stores and bus stops) and the virtual world.

This system further provides a unique user experience that enables organizations engaged in commerce and other types of organizational activity to achieve various key benefits including but not limited to: (a) bridging between the physical world (including stores, bus stops, and at gas pumps) and the virtual world (including the Internet and Web) by creating a dynamic experience for people passing by a window on foot; (b) enabling the operator of the system to better monitor activities occurring on the exterior side of the window; (c) capturing the attention of people passing by the window on a 24×7×365 basis; (d) bridging the physical barrier between what is being offered on the inside of the store and what is visible directly outside of the store; (e) better monetizing the existing investment in physical real estate of the store by allowing third party revenue sources and dynamic pricing and promotions during low traffic periods; and thus (f) yielding higher revenue and higher awareness of available products and services to people that pass by the window.

It should be appreciated that the unique combination of features and functions in the system combine to yield a solution to the full range of problems described in the background section earlier in this document.

To address the problem of stores needing to increase profits by increasing quality, quantity, and duration of interactions with customers, the system provides an engaging and easy-to-use interactive user experience that can deliver on all three of these metrics.

To address the problem of the store window creating a barrier between people on the street and the interior of the store, the system enables a store to better leverage the store window facing the street to lower the barrier through its interactivity. It also creates a bridge between the user's mobile device and the functionality offered by the store that the user has not called up on their mobile device.

To address the problem of closing the gap between the store's physical and online presences, the system enables the store to deliver much of its online functionality to the user while they are at the store.

To address the problem of the one-way advertising nature of current digital and physical signage in store windows, the interactivity also enables the store to conduct an engaging two-way user experience.

To address the problem of users experiencing app fatigue by having to download a new application to their personal mobile device for every store they want to interact with, the system offloads the functionality delivered by the store's mobile application to the local computer, eliminating the need for another application download.

To address the problem of users desiring faster bandwidth, larger display screen sizes and larger user input devices while on the street, the system provides larger form factors and faster connectivity than the currently available mobile devices such as tablets and smartphones or augmented reality glasses (such as Google Glass).

To address the problem of stores (including landlords, owners of stores, and operators of store) needing to better understand their customers and potential customers and deliver more personalized customer experiences, the system provides a sophisticated and flexible approach to user authentication and identity, and the collecting and sharing of data about users across all local computers in the system enables the stores to access a wide and deep set of insights about user behavior and preferences.

To address the problem of stores seeking additional forms of revenue, the system enables stores to participate in and be compensated for affiliating their local computer with a third party advertising network.

To address the problem of stores seeking to increase their per-store sales, the system enables the store to automate certain customer engagement and commerce tasks, providing better leverage to existing store staff.

To address the problem of stores needing to compete with online-only businesses that how lower overhead cost structures, the system provides a cost effective way to gain a competitive advantage by providing all of the above functionality for customer engagement and customer commerce.

To address the problem of the high cost of prior in-store and in-window interactive solutions, the system provides a cost-effective solution that lowers the barrier for stores to implement interactive solutions.

To address the problem of existing capacitive touchscreen technologies that cannot work with double-paned windows containing argon gas between the panes, the system works with any window regardless of its thickness and composition.

Additional features and advantages are described in, and will be apparent from, the following Detailed Description and the figures.

### BRIEF DESCRIPTION OF THE FIGURES

FIG. 1 is front view of one example embodiment of parts of the computerized interactive display system of the present disclosure positioned adjacent to an interior side of a window and partially on an exterior surface of the window.

FIG. 2 is an exploded perspective view of the computerized interactive display system of FIG. 1 positioned relative to a window, and generally illustrating a local computer, a display device, a user input device (in the form of a frosted sticker keyboard), a user input detector, an object detector, a sound emitter, a display device supporter, and a user input detector supporter.

FIG. 3 is a rear view of the user input device (in the form of a frosted sticker keyboard) of FIGS. 1 and 2 mounted on the exterior side of the window, and illustrating a finger pressed against the keyboard, as seen from the interior side of the window.

FIG. 4 is a side view of an alternate embodiment of present disclosure which include a system supporting member which include a floor-to-ceiling pole with multiple supporting arms which support the local components of the system.

FIG. 5 is front view of an alternative example embodiment of parts of the computerized interactive display system of the present disclosure positioned adjacent to an interior side of a window and partially on an exterior surface of the window.

FIG. 6 is an exploded perspective view of the computerized interactive display system of FIG. 5 positioned relative to a window, and generally illustrating a local computer, a display device, a user input detector, an object detector, and a display device supporter.

### DETAILED DESCRIPTION

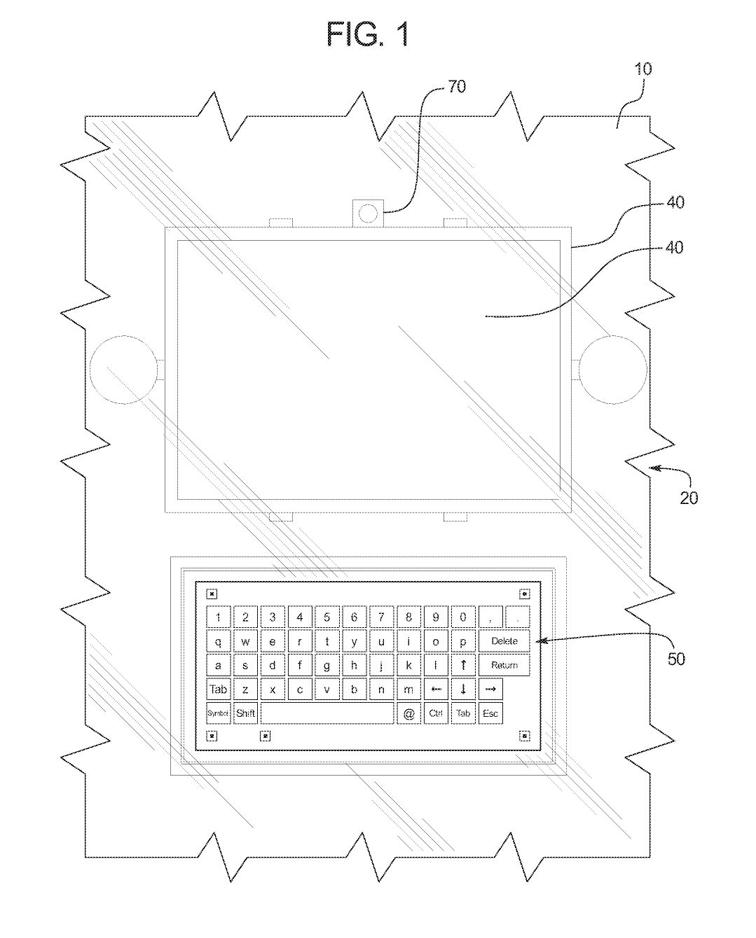

Referring now to the drawings, FIGS. 1, 2, and 3 generally illustrate one example embodiment of the computerized interactive display system of the present disclosure which is indicated by numeral 20. The system 20 of this example embodiment generally includes: (a) a local computer 30 configured to be positioned in an interior space (such as a storefront display area) adjacent to a window 10; (b) a display device 40 configured to be positioned adjacent to an interior surface of the window 10 and controlled by the local computer 30; (c) a user input device such as frosted sticker keyboard 50 mounted on an exterior surface of the window 10 so that a user can touch it; (d) a user input detector such as a digital camera 60 configured to be positioned adjacent to an interior surface of the window 10, configured to detect or capture and record user inputs made using the user input device 10, and configured to communicate with the local computer 30; (e) an outside object detector such as a digital camera 70 configured to be positioned adjacent to an interior surface of the window and configured to detect or capture and record objects outside of the window 10 and configured to communicate with the local computer 30; (f) a sound producer such as speaker 80 configured to be positioned adjacent to an interior surface of the window 10 and controlled by the local computer 30; (g) a display device supporter 42 configured to support the display device 40 adjacent to the window 10; and (h) a user input detector supporter configured to support the user input detector 60 adjacent to the window 10. This system 20 is configured to function through the window 10 and to be fully interactive with a person 95 standing on an exterior side of the window 10 as further described below.

It should be appreciated that in the various example embodiments of the present disclosure described herein, the terms store and stores are meant to include retail stores, wholesale stores, restaurants, banks, service businesses, and other business and organizations with windows or storefronts.

### Local Computer

More specifically, in this illustrated embodiment, the local computer 30 is configured to be positioned in an interior space adjacent to the window 10 (as discussed below) and is configured to control the system 20. It should be appreciated that the local computer can alternatively be positioned at a location further away from the window, such as near the floor base of a floor-to-ceiling pole that supports all of the components. In another alternative embodiment, the local computer could also be located elsewhere in the store and communicate through hardwire or wirelessly with the components located near the window such as the cameras, speaker and displays.

In the illustrated example, the local computer includes a combination of computer hardware and software components which are at least configured to communicate with, control, and receive signals from: (a) the display device 40; (b) the user input detector 60; (c) the object detector 70; and (d) the sound producer 80. The local computer controls these components and enables these components of the system to interact with users of the system as further discussed herein.

In various embodiments, the local computer communicates (via hardwire or wirelessly) with the other components of the system through one or more internal or external USB connections, HDMI connections, Bluetooth connections, NFC readers, and radio frequency identifier (RFID) readers. The local computer works with these other components of the system in terms of data communication (i.e., input/output), data capture (i.e., input), and data display (i.e., output) as generally described herein, although it should be appreciated that these components can function in other manners in accordance with the present disclosure.

In various embodiments of the present disclosure, the local computer is configured to communicate with one or more other or remote computers which are part of the system and/or one or more remote or other computers which are not part of the system (such as computers accessible through the internet). Thus, in various embodiments, the local computer supports high-speed Internet access through a wired connection (such as an Ethernet cable), a Wi-Fi connection to a local Wi-Fi network, 3G or 4G connections to a wireless carrier, or other wireless communication methods (such as a direct satellite connection). It should be appreciated that, in various embodiments, the local computer and the software applications running on the local computer are configured to function in an offline mode in the event that Internet access is unavailable for an unspecified length of time.

It should further be appreciated that the system may operate through any suitable wired, partially wired, or wireless data network. It should further be appreciated that the system of the present disclosure can operate through any suitable central or remote network such as but not limited to a local area network (LAN), a wide area network (WAN), an intranet, and the internet (such as through cloud computing). It should also be appreciated that the system may also exchange data with other network devices via a connection to a data network. The network connection may be any suitable type of network connection, such as an Ethernet connection, digital subscriber line (DSL), telephone line, coaxial cable, etc. It should thus be appreciated that some or all of the data storage and/or data analysis functions of the system can be done remotely.

It should be appreciated that in various alternative embodiments, the system of the present disclosure includes: (a) more than one local computer which control the system; (b) one or more local computers configured to communicate with one or more remote computers for controlling the system; (c) one or more local computers which control the system and which also communicate or operate with one or more remote computers to enable the local computers to control the system; and (d) one or more remote computers which control the system (without the local computers). In various example alternative embodiments of these combinations of local and remote computers, one local computer is configured to communicate with one or more remote computers to control the system.

In certain embodiments, the system includes multiple sets of input/display device combinations such as a user input detector (e.g., keyboard camera or sticker camera), a display device, and a user input device (e.g., sticker keyboard on the window of a physical location or store), which enable multiple users to interact with the local computer(s) at the same time in separate user experiences. In one sense, the local computer(s) operate(s) as a server hosting multiple virtual machines, supporting the computing needs of the multiple sets of input/display device combinations. This is similar to desktop virtualization functionality provided by Citrix and VMware.

It should further be appreciated that in various embodiments, multiple system implementations in multiple businesses will be implemented and that each of the local computers of those system implementations will be in communication with one or more remote central computers to provide the various functions of the present disclosure. Thus, it should be appreciated that: (a) in certain embodiments the system only includes the local computers; (b) in other embodiments, the system only includes the remote computers; and (c) in other embodiments, the system includes the local and remote computers (such as the central computers).

It should also be appreciated that the example embodiments described herein are primarily directed to the example embodiments of the present disclosure that employ local computers, but that such systems are not intended to limit the scope of the present disclosure.

In various embodiments, the local computer includes one or more central processor boards with one or more processors (such as microprocessors) and one or more memory devices. More specifically, it should be appreciated that the processor(s) of the local computer can be any suitable type of processor(s) such as but not limited to one or more microprocessor(s) from the INTEL PENTIUM® family of microprocessors or processors based on the ARM architecture. It should be appreciated that the memory or data storage device(s) of the local computer can be any suitable type of memory or data storage device which includes volatile memory and non-volatile memory such as but not limited to: random access memory (RAM), non-volatile RAM (NVRAM), magnetic RAM (MRAM), ferroelectric RAM (FeRAM), read only memory (ROM), flash memory, and/or EEPROM (electrically erasable programmable read only memory), other suitable magnetic memory devices, any optical memory device, or any semiconductor based memory devices). It should also be appreciated that the memory or data storage device(s) can be configured in any suitable manner to store part or all of the program code and/or operating data for performing the functions described herein for the local computer. The local computer may also include a hard drive, CD drive, DVD drive, and/or other storage devices suitably connected to processor(s). The memory or data storage devices stores each of the software programs or applications executable by the processor(s) to enable the local computer to function with the: (a) the display device 40; (b) the user input detector 60; (c) the object detector 70; (d) the sound producer 80; and (e) any other components of the system, and to provide the various functions of the system described herein.

In various embodiments, the system includes one or more databases located on each local computer that supports all local computer applications and services. The databases also provide the ability to support additional external input, output, and input/output devices.

In various embodiments, the local computer is configured to use an open hardware architecture so that additional devices can be attached to the system and utilized by the local computer software applications.

As further discussed in detail below, the local computer alone or in combination with one or more remote or central computers are configured to provide the various functions of the system and for the users of the system.

### Display Device

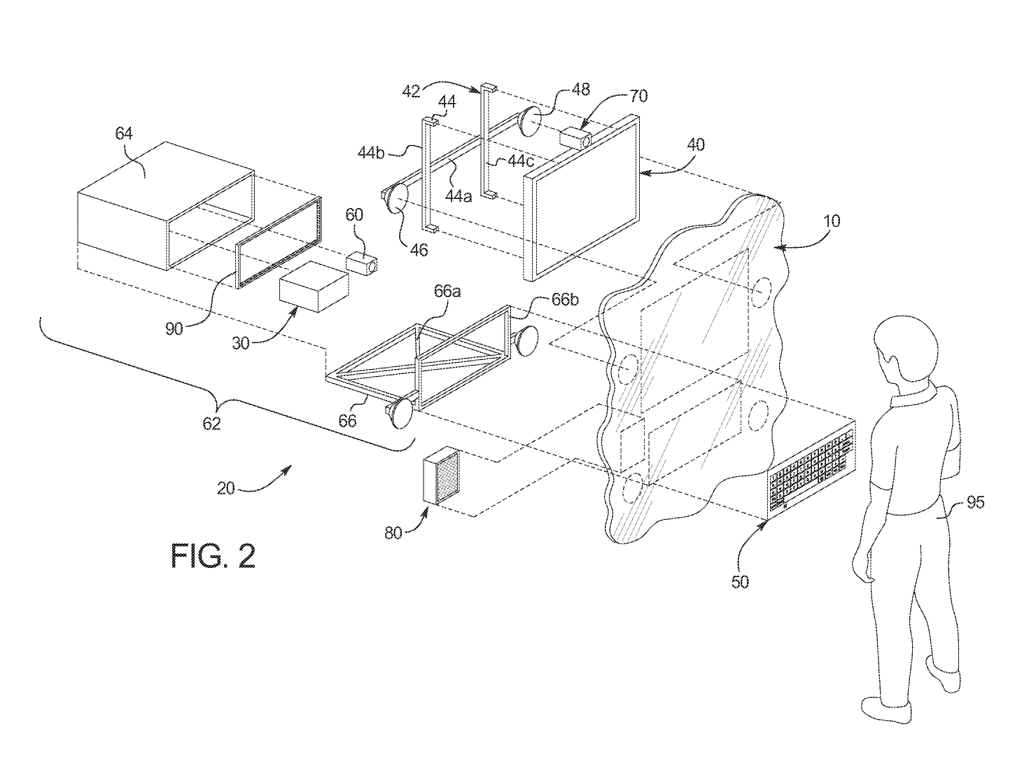

In the embodiment illustrated in FIGS. 1 and 2, the display device 40 is configured to be positioned adjacent to an interior surface of the window 10 and is controlled by the local computer 30. The display device 40 is configured to display visual images (such as video displays) to the people who use the system on the outside of the window as well as to the people who pass by the window 10. The display device 40 is configured to receive signals or visual image feeds from the local computer 30 (via hardwire or wirelessly).

Although FIGS. 1 and 2 illustrate only one display device, it should be appreciated that the present disclosure contemplates that the system can alternatively include multiple display devices of the same type or of different types. In the embodiments where the system includes multiple display devices, the local computer is configured to send the same or different visual image or video feeds to the display devices. For example, in one embodiment, the local computer is configured to control five display devices including two monitor displays, two laser displays, and one projected display, and to send different visual image feeds or control signals to each different display device. In another example embodiment, the local computer controls a primary monitor display device as well as a secondary privacy protector display that is much smaller and is configured to show on the screen the various keyboard outputs as they are typed. The secondary privacy protector display is discussed in more detail below.

It should thus be appreciated that the display device(s) of the system of the present disclosure can be any suitable type of display devices. For example, each display device can be: (a) a computer monitor or display; (b) a television; (c) a plasma display; (d) a liquid crystal display (LCD); (e) a light emitting diode (LEDs) display; (f) a organic light-emitting diodes (OLEDs) display; (g) a polymer light-emitting diodes (PLEDs) display; (h) a surface-conduction electron-emitters (SEDs) display; (i) a display device providing a projected image; or (j) a display device providing a reflected image. It should further be appreciated that one or more of the display devices can include a laser display that uses one or more lasers to project images onto the window or onto a surface adjacent to the window such as a wall or the ground. It should further be appreciated that one or more of the display devices can include projected displays that use video projector technology to project visuals onto the window or onto a surface adjacent to the window such as a wall or the ground. It should further be appreciated that one or more of the display devices can include digitally-controlled lighting installations which enable the local computer to control one or more lights based on specific desired functionality of the system (thereby providing multiple types of control such as off/on, levels of lighting intensity, variations in lighting colors and the direction that the lighting is thrown).

In various embodiments, the display device has a relatively a large screen which is viewable from a distance such as across a street or farther down the street. In other embodiments, the display device includes a relatively smaller screen intended to communicate a much more limited set of information, such as only what the user has typed on the display device. In various other embodiments, the display devices include the combination of different size display devices such as a relatively a large screen and a relatively smaller screen.

In other alternate embodiments, when the display device is built into a tablet computer that is used as the local computer, the display device (and entire tablet computer) can be positioned in a cradle on its side or upside down. These embodiments enable the system to utilize a built-in camera (or built-in cameras) in the tablets and thereby enable the cameras to be positioned for the field of view that is necessary for the function of the camera.

### Privacy Screen for Display Device

Although not shown, as mentioned above, the present disclosure contemplates that one or more of the display devices can be covered or protected with a suitable privacy screen protector which prevents all or part of the screen of the display device from being seen by someone who is near the screen of the display device but is not the current user. This is to help ensure that any confidential information that the user enters into the system such as a date of birth or credit card number are not readily visible to other people on the side wall or street. It should be appreciated that there are several different embodiments that provide privacy protection, and that these embodiments can be utilized in combination with each other or alone.

The first embodiment of the privacy screen protector includes a film that is physically placed directly over any display to prevent the screen from being seen by a person looking at the screen who is not standing directly in front of the screen. Various forms of this embodiment are currently manufactured for mobile devices (such as laptops, tablets, and smart phones).

A second embodiment of the privacy screen protector includes an additional display that is much smaller and configured to show on the screen the various keyboard outputs as they are typed. This approach is akin to how typing was displayed on the screen of an electric typewriter before it was typed on the page, or how a calculator displays letters as they are typed. Further protection for the user can be offered by locating this alternate display slightly recessed from the window, making it more difficult for anyone not standing directly in front of the display to read it. One example of this type of display is the SmartType keyboard hardware product.

The third type of embodiment provides a screen-in-screen type of functionality where a small portion of a full display is allocated by the software to be the location on the display device where sensitive information is displayed. Any information displayed on this screen-in-screen is rendered in a much smaller font size, making it more difficult to be read by anyone not standing directly in front of the screen-in-screen.

The fourth type of embodiment hides specific instances of sensitive information such as passwords by displaying a special character such as a “*” on any display instead of the actual character that was typed.

It should be appreciated that other suitable privacy protectors may be employed in accordance with the present disclosure.

### Combination Local Computer and Display Device Alternative

It should be appreciated that the present disclosure contemplates that computing devices (such as desktop computers, laptop computers, and tablets) which include both a computer and a display device may be employed in the various embodiments of the present disclosure to provide both the local computer and the display device. It should also be appreciated that the present disclosure contemplates that one or more tablets may be employed (but not necessarily being used as the local computer that coordinates all operations at the window) for certain system functions and in such case would be configured to work in conjunction with the local computer.

### User Input Device, User Input Detector, and User Input Software

In various embodiments of the system, a combination of three components are used together to enable the user to input information into the local computer. The first component is a user input device, which is the physical component that the user will directly interact with (such as a keyboard). The second component is the user input detector, which detects or captures and records the inputs that the user makes using the user input device and transfers them as digital signals to the local computer. The third component is the user input software, which the local computer executes to receive the digital information from the user input detector and which includes algorithms to turn the digital signals into structured inputs that can be further processed by the local computer.

In one preferred embodiment, the user input software operates directly on or is executed directly by the local computer. In certain alternative embodiments, the user input software operates on or is executed by a separate processor board (or multiple processor boards) which has been optimized to more quickly and efficiently operate or execute the software's algorithms. In such case, the separate processor board transmits the processed signals back to the local computer as structured information or data.

One example embodiment of this is the mounting of a computer optical mouse directly onto the interior of the window. The mouse enables the user on the exterior of the window to use hand gestures such as side-to-side or up-and-down hand gestures in front of the mouse. The internal sensors built into the mouse detect the gestures and process this data using the computer processing hardware and firmware built into the mouse. This data is then sent back to the local computer for processing.

In an alternate embodiment, an external lens is placed on top of the optical detection hardware to further adjust the focal point of the mouse and extend the viewing range of the mouse. This configuration changes where the camera looks and the direction of the camera's lighting to push the focal point from a few millimeters from the mouse to a few centimeters from the mouse so that it works behind both a single pane of glass and a double pane of glass.

In one preferred embodiment, the user input detector uses hardware and software functionality built directly into the local computer. In certain alternative embodiments, the user input detector operates as an external hardware component that is connected to the local computer either through hardwire or wirelessly.

In the illustrated embodiment of FIGS. 1 and 2, the user input device 50 is in the form of a sticker keyboard mountable or mounted on an exterior surface of the window 10. The user input device 50 in part enables people on the exterior side of the window 10 to interact with the system 20 which is primarily on the interior side of the window 10. In various embodiments, since the user input device 50 is on the outside or exterior of the window, it needs to work in a variety of physical conditions, including heat, cold, rain, snow, ice, and during changing lighting conditions (such as during the days and nights).

Generally, in this illustrated embodiment, the user input device 50 includes a sticker keyboard having a body or membrane formed with a plurality of keyboard position locators on the exterior side of the membrane and a grid with a plurality of keys on the exterior side of the membrane.

More specifically, in this illustrated embodiment, the sticker keyboard includes a relatively thin body or membrane configured to be attached to the window using a peel-off backing that protects (prior to removal) a transparent keyboard sticker adhesive. The sticker keyboard can be manufactured in a variety of different ways. One method includes placing a blank vinyl sticker sheet that has a translucent coloring (giving the appearance of looking frosted over) in a suitable printer such as a laser jet printer that employs ink that bonds under the heat of the laser to the vinyl to create a lasting impression on the vinyl membrane. Another method uses an inkjet printer that uses large heating elements in it to bond the ink to the vinyl sticker sheet after it runs through the heads. After the sticker is printed using one of these methods, the sticker is run through a plotter to cut out the desired shape. In an alternative embodiment, the membrane is printed on and then die cut.

In this illustrated embodiment, the keyboard position locators of the sticker keyboard include a plurality of markings such as unique markings printed on the exterior side of the sticker which enables the user input detector 60 to co-act with the local computer and the keyboard software application to identify the exact position of the sticker keyboard on the window 10 and thus to determine which keys are pressed by the user as further explained below. It should be appreciated that these marking can alternatively be printed on the interior side.

In this illustrated embodiment, the keys of the sticker keyboard include conventional keyboard keys including: (a) 0 to 9; (b) A to Z (upper and lower case); (c) a plurality of different special characters such as the @ symbol and the $ symbol; and (d) navigational keys such as the up, down, left, and right arrows or back, forward and Home buttons. It should be appreciated that the keys can include any suitable symbols configured to represent any suitable specific functionality (such as a picture key which causes the system to immediately take a photograph of the user). Although not shown in FIGS. 1, 2, and 3, the present disclosure contemplates that the sticker keyboard can additionally include one or more mouse areas or touchpad areas that enable the user to user to make mouse like or touchpad like inputs for precise display screen navigations.

In some cases, the touchpad sticker is placed proximate to the display. The display can then produce an image that gives the appearance of being buttons (or other types of inputs) that are labeled with text or icons, producing the effective of a soft button that can be dynamically generated to create the impression that the user is working with a touchscreen device. For example, the display could contain two squares signifying two buttons on the screen with the word “Yes” in one square/button and the word “No” in the other square/button. When the user presses on the part of the touchscreen proximate to one of the digitally displayed buttons, the user input detector will detect the action and the user input software will convey the appropriate “yes” or “no” command to the device.

This disclosure also contemplates that the sticker keyboard can include a separate area specifically sized for a user to hold a credit card up to window so that the system can record a video or photograph of the credit card.

In an alternative embodiment, the keyboard includes or defines an interior cavity or slot for receiving the credit card such that the credit card can be inserted into the cavity or slot which enables the credit card to be covered relative to the outside. In one embodiment, the cavity or slot is configured such that exterior lighting does not enter the cavity or slot when the credit card is not present in the cavity or slot.

In various embodiments, each sticker is printed or otherwise formed with a version identification marking such as an ID number printed in digits or in a QR code. When the user input detector (explained later in this document) recognizes an ID number, it will automatically utilize software trained to interpret user actions on that specific keyboard version.

In alternative sticker keyboard embodiments, one or more of the keys also function as keyboard position locators. In certain of these embodiments, one or more of the keyboard position locators can be eliminated from the sticker keyboard.

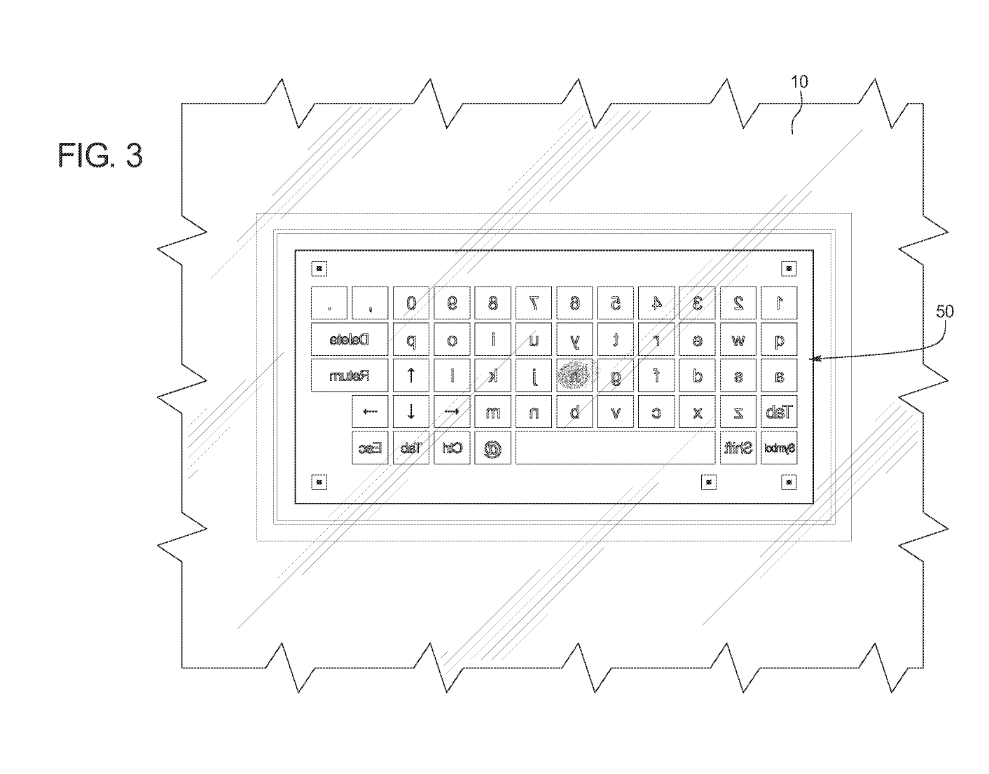

As generally illustrated in FIG. 3, the sticker keyboard enables a person to use his or her fingers (either directly or wearing a glove) to press on the exterior-facing surface of the sticker keyboard affixed to the exterior of the window at the locations of the keys to make inputs into the system. Since the sticker is translucent, each finger press or the pressing action of a key on the outside of the sticker keyboard changes what is seen on the interior side of sticker keyboard in the specific location of the pressed key as shown by FIG. 3. Instead of the “frosted” background color that is normally seen on the back side of that part of the sticker when nothing is pressing against it, the back of that part of the sticker changes to look like a finger (or glove) is being firmly pressed against the window. FIG. 3 illustrates the backside of a sticker keyboard with a finger on the other side pressed against the key for the letter “h”; however, it should be appreciated that the sticker keyboard may be otherwise suitably configured such that this image looks different than shown in FIG. 3.

In various embodiments, the user input detector 60 records a digital video of the interior side of the sticker keyboard and sends data representing this digital video to the local computer. In various embodiments, the local computer includes or executes user input software in the form of a keyboard software application executed by the local computer to interpret this data of the digital as structured keyboard inputs by the user.

In the illustrated embodiment of FIGS. 1 and 2, the user input detector 60 is in the form of a camera or keyboard camera positioned adjacent to an interior surface of the window 10, and configured to detect user inputs made using the user input device 50 such as the sticker keyboard. The keyboard camera is positioned vertically and horizontally at the same or approximately the same height as the sticker keyboard and horizontally central to the sticker keyboard. This positioning enables the keyboard camera to frame the entire sticker keyboard in its line of sight.

In various embodiments, the user input detector 60 is in the form of one or more keyboard cameras such as one or more digital cameras that capture digital photos and digital video of the back or interior-facing side of the sticker keyboard 50 attached to the exterior surface of the window 10.

The user input detector 60 is configured to record inputs made by a person on the keyboard 50 and to communicate digital video feeds or data signals of these inputs to the local computer 30 as discussed above and below. In various embodiments, the user input software or keyboard processor software application is on or executed by the local computer 30 which processes the video feeds or data signals as described above and below to determine the inputs of the user.

In this illustrated embodiment, the sticker keyboard does not include any attached or embedded digital or electronic components. In this illustrated embodiment, this user input device or sticker keyboard is not connected (by wire or wirelessly) to the local computer. Accordingly, the cost of the sticker keyboard and installing the sticker keyboard is relatively small. If the sticker keyboard is removed from the exterior of the window, stolen from the exterior of the window, or damaged, the relative cost and damage to the system is minimal, and the sticker keyboard can be easily and inexpensively replaced

It should also be appreciated that in alternative embodiments (to further protect the sticker keyboard from being removed from the exterior of the window, stolen from the exterior of the window, or damaged), the sticker keyboard is placed on the interior surface of the window. In these embodiments, the user will touch the areas of the window at the locations of the keys. As mentioned above, each finger press or the pressing action of the window in the locations of the keys of the keyboard changes to look like a finger (or glove) is being firmly pressed against the exterior of the window. When seen from the inside of the window, it creates the appearance that a finger (or glove) is being pressed on a specific button or part of the keyboard sticker as generally illustrated in FIG. 3.

It should be appreciated that the sticker keyboard can be made in a variety of different sizes, shapes, and colors. It should also be appreciated that the sticker keyboard can be manufactured as one piece or in multiple pieces or sections (such as with a separate section for a virtual mouse pad).

It should be appreciated that the present disclosure contemplates various embodiments that provide variations on the sticker keyboard as the user input device, while retaining the use of a keyboard camera (as the user input detector) and the related keyboard processor software application (as the user input software) to detect changes on a structured keyboard and interpret them as keyboard inputs.

In one alternate embodiment, the system includes an event detector (which is provided by the user input software) connected to a vibration sensor (functioning as a second user input detector) that is mounted on the window and configured to notify or send signals to the local computer (which are processed by the local computer executing the keyboard processor software application) and that detects tap vibrations on the window. The local computer (executing the keyboard processor software application) correlates this information with the event detection of a finger pressing against the keyboard. The occurrence of a tap vibration can thus be used to help guide to algorithms to a more accurate interpretation of the user's actions on the keyboard.

In another embodiment, a morie pattern phenomenon is used to increase the visibility of changes in the position of the keys. By using a parallel line pattern on the keys and a transparent sheet, an interference pattern can result which is highly sensitive to relative motion between the sheets. Such a pattern is highly visible and can be used to make the key motion easier to see by the user input detector.

In another example embodiment, the sticker keyboard includes a sticker keyboard which includes two attached bodies or members such as a front film and a back film. The front film faces the user and the back film is transparent and is attached to the window using a suitable adhesive. The two members include a keyboard printed on the exterior-facing or front body or member and a differently colored fluid or gel substance between the two bodies or members. When each key is pressed, the two members come in contact and the gel substance is forced out of the vicinity of press, thereby causing the front film to be visible through the transparent back film. Such a phenomenon creates a distinct visible pattern which is detected by the user input detector 60.

In another example embodiment, the sticker keyboard includes a vacuum bubble keyboard which includes a vacuum formed body or member which has a grid of keys and a reflective coating on the interior side of the body or member. Each key is printed with a dome shape that deforms when pressed. When each key is pressed, the reflective coating on the backside of that key deflects or reflects light thereby creating a distinct visual phenomenon which can be detected by the user input detector 60.

In another example embodiment, the user input device includes a projected keyboard which includes an image of a keyboard projected onto the window (similar to the technology from Magic Cube). When each key is pressed, the user input detector records a digital video of the window and sends data signals of this digital video to the local computer. In various embodiments, the local computer executes the user input software to receive this digital information and process it into structured inputs for the local computer.

It should also be appreciated that the local computer can use one of several completely different combinations of a user input device, the user input detector and user input software which do not involve a sticker keyboard as a user input device and the keyboard camera as the user input detector.

In one alternative embodiment, the user input device utilizes a passive radio technology (such as RFID, NFC, or a similar approach). In this embodiment, the keyboard includes a body or member which has a grid of keys. Each key is printed on a dome that deforms when pressed. When each key is pressed, a circuit is completed for a low powered radio-chip causing the chip to emit a unique signal to a user input detector (such as in the form of a RFID, NFC, or similar reader) which is connected to the local computer. The local computer executes user input software to receive this digital information and process it into structured inputs for the local computer.

In another example embodiment, the user input device includes a light sensing keyboard which includes a keyboard pattern printed on an otherwise transparent or translucent body or member affixed to either the interior or the exterior of the window and a grid of sensors affixed to the interior surface of the window, with each sensor corresponding to a specific keyboard “key.” Each sensor senses a change in light condition when the user's finger covers that specific sensor. When each key is pressed, the sensor sends signals to the user input detector which is connected to the local computer which uses or executes a sensor keyboard software application to interpret the signals. The local computer executes the user input software to receive this digital information and process it into structured inputs for the local computer.

In various other example embodiments, the system includes one or more input devices and one or more display devices that are connected to the local computer and that enable one or more users who are on the interior side of the window (such as in the store) to interact with the system. In these embodiments, the user input device includes an active (i.e., traditional) keyboard on interior side of window that is connected to the local computer either through hardwire or wirelessly.

### Gesture-Based Input Detector

In various embodiments of the present disclosure, the system includes one or more gesture-based input detector(s) which differ from the keyboard approaches discussed above in that instead of the user pressing on a surface to simulate a key or a touch screen or cursor movement, the user makes gestures (either individually or using any combination of arms, hands, fingers, head, torso, legs, eyes and eyeballs, legs, feet and/or the entire body) and the system captures those gestures. In various embodiments, the street traffic camera or a dedicated camera for gesture input captures the gestures and sends the data feeds or signals to the local computer or an external processor board. The local computer or the external processor board execute software on the local computer or external processor to translate the data signal of the gestures into structured commands for the local computer.

The system of the present disclosure can employ known gesture processing systems. One such system is OpenCV, which is an open source software development kit created by Intel for Perceptual Computing. Another of the most prominent current gesture-based input systems is Microsoft's Kinect and the software development kit (SDK) that is available to work with the Kinect. Another example is the not-yet-released Leap gesture input technology, which is advertised as being 200 times more accurate than anything else on the market (at any price point), being close to the size of a flash drive, and being able to distinguish individual fingers and track movements down to a 1/100th of a millimeter. Other existing gesture processing solutions include hardware and or software technologies from the Israeli companies PointGrab, eyeSight, and PrimeSense.

In further alternative embodiments, the system also uses a camera as a user input detector and specialized software algorithms as the data input software executed by the local computer to identify the mouth of a user and then perform lip reading of the user using computer vision software. This will enable the data input software to translate the movements of a user's mouth into specific words that can be passed to the local computer as inputs.

In further alternative embodiments, the system also uses a camera as a user input detector and specialized software algorithms as the data input software executed by the local computer to identify facial expressions and expressions of emotion of a user.

### User Mobile Device Detector

In various embodiments of the system, a combination of hardware and software is used to detect the presence of nearby mobile devices (such as smartphones and tablets) being carried by users and potential users. This functionality is build upon approaches deployed by others such as solutions from Libelium's Meshlium Xtreme that can detect and uniquely identify mobile devices in the vicinity using communication protocols such as WiFi and Bluetooth. Specifically, the Xtreme product can gather the following information from each device: (1) the MAC address of the wireless interface, which enables a unique identification of the device; (2) the strength of the signal (RSSI), which enables calculation of the average distance of the device from the scanning point; (3) the vendor of the Smartphone (e.g., Apple, Nokia, etc); (4) the WiFi Access Point where the user is connected (if any) and the Bluetooth friendly name, or if the user is not connected; and (5) the Class of Device (CoD) in case of Bluetooth which enables the solution to differentiate the type of device (e.g., Smartphone, Handsfree, Computer, LAN/Network AP) and to differentiated between devices held by pedestrians and devices in vehicles. The system will be able to collect this data and use this data with one or more other functions of the system described herein or subsequently added to the system to provide additional functionality. For example, the system may use this data with suitable software (such as the Nomi product) to provide targeted in-store analytics.

### Audio Input Device

Although not shown, various embodiments of the system of the present disclosure include one or more audio input devices which are configured to capture the voices or other sounds made by the users. In various embodiments, the audio input device includes one or more microphones mounted either on the interior side of the window or adjacent to the interior side of the window. The microphones capture sounds spoken by the user on the exterior side of the window. The microphone is configured to communicate (by wire or wirelessly) to the local computer. For example, the microphone can be connected to the local computer through wirelessly using a Bluetooth connection or wired using a USB connection or the local computer's microphone input jack. The microphone can be powered by battery, hardwire to the local computer or to an external power source or by induction. In alternate embodiments, the microphone is installed close to where the user stands on the exterior side of the window or adjacent to the exterior side of the window. In various such embodiments, the microphone is also powered by electricity induction through the window.

### Inside and Outside Object Detectors

In the illustrated embodiment of FIGS. 1, 2, and 3, the object detector 70 is positioned adjacent to an interior surface of the window and configured to detect objects outside of the window 10.

In various embodiments, the object detector includes a street traffic camera such as one or more digital cameras (to capture narrow or broad fields of vision) that captures digital photos and digital video of the exterior scene through the window 10. It should be appreciated that different types of lenses can be placed on the street traffic camera (such as fisheye and wide angle and micro lenses) to capture different images. In various embodiments, each street traffic camera is configured to capture one or more sets of information or data, including but not limited to the following: (a) people, vehicles, and bicycles passing by the window; (b) people who approach the window; (c) headshots of people who approach the window or use the system through the window; (d) people who enter the store; and (e) people who exit the store.

The outside object detectors are configured to communicate data signals of the digital photos and digital video representing those detected objects to the local computer 30 which processes these data signals as further discussed below.

Although not illustrated in FIGS. 1, 2, and 3, it should be appreciated that the present disclosure further contemplates that the system can have additional object detectors such as one or more inside object detectors. In various embodiments, the inside object detector includes one or more store traffic digital cameras (to capture narrow or broad fields of vision) that captures digital photos and digital video of the interior spaces of the stores, and specifically tracking individual people who have entered the store. Different types of lenses can be placed on the store traffic camera including fisheye and wide angle and micro lenses to capture different images. Each store traffic camera is configured to capture one or more sets of information or data, including but not limited to the following: (a) people who enter the store; (b) people who exit the store; and (c) people while they are inside the store, including while browsing products, shopping, interacting with store workers, or conducting a transaction (such as making a purchase of a product).

The inside object detectors are configured to communicate data signals representing the digital photos and digital video of those detected objects to the local computer 30 which processes this signals as further discussed below.

In various embodiments (similar to the user input detectors), the object detector processor software operates directly on the local computer. In alternative embodiments, the user input software operates on a separate processor board (or processor boards) which is optimized to more quickly and efficiently operate the software's algorithms. In such embodiment, the processor board transmits the processed signal back to the local computer as structured information.

In an alternate embodiment, additional detectors are installed to detect the nearby presence of smart-phones, tablets, and other mobile computing devices. These detectors, which are currently available as commercial products from companies such as Libelium, scan using different protocols such as WiFi, Bluetooth and Zigbee, and detect the presence of any device in the area that will communicate with the detector. The detected devices provide a unique identification number, enabling the system to develop a catalog of detected devices and the dates and times of each of the detections. These can be linked to user account records when this linkage is possible. This data will then be made available to applications on the local computer and through databases on the remote computer.

### Sound Producer

In the illustrated embodiment of FIG. 2, the sound producer 80 is in the form of a speaker configured to be positioned adjacent to an interior surface of the window 10 and controlled by the local computer 30. The speaker produces or produces sound for the user's benefit. It should be appreciated that the system can include more than one sound producer such as multiple speakers. The sound producer 80 is shown adjacent to the window 10; however, it should be appreciated that the sound producer may be alternatively positioned.

The sound producer(s) can be any suitable types of sound producer. In one example embodiment, the sound producer includes one or more speakers mounted adjacent to or on the interior surface of the window and which reproduce or produce sounds in accordance with data signals sent from the local computer. In various embodiments, the speaker is connected to the local computer wirelessly using a Bluetooth connection or wired using a USB connection or the local computer's audio output jack. In one embodiment, the speaker is mounted to the interior surface of the window by a gel like substance which enables the interior sound to be heard by people on the exterior side of the window. The sound is audible to a user of the system on the exterior side of the window and the volume can be adjusted to be higher or lower so that it is also audible to people passing by the exterior side of the window on the adjacent street. One example of this type of speaker which can be employed in accordance with the present disclosure is the WOWee One Power Bass Portable Speaker which uses Gel Audio™ technology to project low frequency sound waves through the bottom of the WOWee, utilizing the object or surface it touches into as a platform for a subwoofer.

In another example embodiment, a speaker with Gel Audio type technology is integrated into the same enclosure as the local computer processor and/or display, getting the same effect as the above in a more compact, inexpensive housing and reducing the number of electronic components in the local computer.

In another example embodiment, the sound producer includes one or more speakers mounted on or adjacent to the exterior side of the window. The sound is audible to a user of the system on the exterior side of the window, and the volume can be adjusted to be higher or lower so that it is also audible to people passing by the exterior side of the window on the street. In this embodiment, the speakers are connected to the local computer wirelessly using a Bluetooth connection or wired using a USB connection or the local computer's audio jack.

In various embodiments, the sound producer on the exterior side of the window is powered with induction power transmitted through the window or by an internal battery power source.

The present disclosure contemplates that any suitable sounds can be produced or reproduced by the sound producer to enhance the user experience and to attract people who pass by the window. For example, the sound producer can produce or reproduce: (a) ambient music; (b) voice or vocal instructions; (c) voice or vocal advertising; and (d) touch screen feedback confirmation of having performed a user input action or keyboard action with a beep and/or a vibration produced by a sound with a low base.

It should also be appreciated that in various embodiments of the present disclosure, the sound producer produces specific audio signals at a high enough pitch that while it is still audible to another device with a microphone, the pitch of the sound is too high to be audible to humans. Each device can then be provided a distinctive, high-pitch audio signature that uniquely identifies that device. The present disclosure contemplates that users will be able to download an app to their mobile device that is configured to listen for this audio signature and identify which device specific they are standing near. Once this identification has been made, the user's mobile device and the local computer will be able to authenticate each other and the user will be able to interact with the local computer on the inside of the window using his/her own mobile device. This system may employ or build on a technology developed by Shopkick that employs an audio speaker to emit a unique audio signature at a high enough pitch that while it is still audible to another device with a microphone, the pitch of the sound is too high to be audible to humans.

### Display Device Supporters and User Input Detector Supporters

In the illustrated embodiment of FIGS. 1, 2, and 3, the display device supporter 42 is configured to support the display device 40 in a position adjacent to the interior surface of the window 10. In this illustrated embodiment, the display device supporter 42 generally includes a frame 44 and a plurality of window attachers 46 and 48.

More specifically, in this illustrated embodiment, the frame 44 includes supports 44a, 44b, and 44c suitably attached to each other and configured to securely hold display device 40. It should be appreciated that the present disclosure contemplates that the frame can be alternatively configured, sized, and shaped and can include additional supports or different supporting structures. In one example embodiment, the frame is shaped so that it fits closely to the edges of all four sides of the display, so that the frame supports every external part of the display.

In this illustrated embodiment, the window attachers 46 and 48 are respectively connected to support 44a and configured to securely hold frame 44 and the display device 40 to the window. In this illustrated embodiment, the window attacher 46 and 48 are suction cups. In alternate embodiments the window attachers can work to hold together the various components of the local computer (such as the external enclosure and the interior electronics) in place using alternate technologies such as adhesives. One example of such adhesives is 3M's VHB Tape. It should be appreciated that the present disclosure contemplates that the window attachers can be alternatively configured, sized, and shaped and can include additional attachers.

It should further be appreciated that the present disclosure contemplates that other suitable display device supports can be employed in the system to hold the display device adjacent to the interior side of the window. For example, in alternate embodiments, separate supporters attached by separate suction cups or attached to other parts of the cradle can be deployed to support additional devices such as microphones, additional cameras and additional monitor displays. These supporters can be positioned so that the devices are held at either side of, or on top of or below the center of the installation.

In this illustrated embodiment, the user input detector supporter 62 is configured to support the user input detector such as camera 60 in the interior space adjacent to the window 10 and at relatively the same height as the sticker keyboard 50.

In this illustrated embodiment, the user input detector supporter 62 generally includes a housing 64 and a window attacher 66.

More specifically, in this illustrated embodiment, the housing 64 includes multiple walls suitably attached to each other and configured to form a front open ended box and configured to hold the user input detector supporter and particularly the camera 60. It should be appreciated that the present disclosure contemplates that the housing can be alternatively configured, sized, and shaped.

In certain embodiments, the housing 64 also functions to control the backlighting that surrounds the camera 60 to make the quality of the digital video images captured by the camera 60 more consistent at all times and more easily readable to the algorithms in the user input software that processes the data signals representing the digital video. More specifically, in various embodiments, the interior walls of the housing are brightly colored (using paint or a brightly colored paper attached with an adhesive) to better reflect the light. Additionally, in the illustrated embodiment, the system includes a light board 90 using LED lights which provides additional lighting paper to enhance the interior lighting of the housing. These two elements combined enhance and make consistent in all situations (such as different times of the day, different weather conditions, and different levels of lighting in the interior area adjacent to the system installed proximate to the window) backlighting for the sticker keyboard 50.

In various embodiments, the housing: (a) includes one or more internal sliding mechanisms configured to hold the various components of the system; and (b) defines one or more holes which enable the wires (not shown) to be attached to devices inside the housing and then run out to devices outside the housing such as electrical outlets or external speakers or display devices.

In various embodiments, the housing is extended, or a second housing is employed to create a barrier between the rear of the display and the interior of the store. This housing is used to enhance the aesthetics of the display, so that they do not detract from the aesthetics of the interior of the store. This housing also serves to protect any functional components on the rear of the display from intentional or unintentional contact with a foreign object such as the arm of a person or a package that is being moved by a person.

Referring back to FIG. 2, in this illustrated embodiment, the window attacher 66 includes a base 66a configured to securely hold the housing 64 and a window engager 66b configured to be attached to the interior surface of the window 110. In this illustrated embodiment, the window engager is connected to the interior surface of the window by suction cups. It should be appreciated that the present disclosure contemplates that the window engager can be alternatively configured, sized, and shaped.

Though not illustrated, one alternate embodiment utilizes a devices that provide a combination of a controller, a temperature sensor and a heating element to ensure that the temperature on the window where the suction cups are placed does not fall below a specific temperature. The specific temperature would be defined on the controller to be one at which an affixed suction cups cannot come loose from the window due to the cold. In one embodiment, one device is installed to be close to every suction cup. In another embodiment, one device could control the temperature on the window for a sufficient area to be able to work with multiple suction cups.

It should further be appreciated that the present disclosure contemplates that other suitable display device supports can be employed in the system to hold the user input detector adjacent to the interior side of the window. For example, in other embodiments, the user input detector is held in place by attaching it to an existing part at the bottom or rear of the display such as the part of the bottom of the display configured to hold the display up from a stand. Alternatively, the user input detector is held in place (such as by an adhesive or other mechanism) to the rear of the display which could also serve as a shelf on which to place components.

In this illustrated embodiment, the user input detector supporter 62 is also configured to support the local computer 30; however, it should be appreciated that a separate local computer support or cradle can be employed next to the window or in close physical proximity to the window in accordance with the present disclosure. It should also be appreciated that the local computer can be supported by the display device supporter.

For example, in other embodiments, the local computer is held in place by attaching it to an existing part at the bottom or rear of the display such as the part of the bottom of the display configured to hold the display up from a stand. Alternatively, the local computer is held in place (such as by an adhesive or other mechanism) to the rear of the display which could also serve as a shelf on which to place components.

The present disclosure further contemplates that the display device supporter and the user input detector supporter can be combined into a single supporter or housing that is attached to the interior side of the window or that is positioned adjacent to the interior side of the window. In one such embodiment, the system includes a suitable display stand which rest on the floor or area adjacent to the interior side of the window. It should thus be appreciated that the present disclosure contemplates that the display device does not need to be directly attached to the interior side of the window, but rather can be positioned somewhat spaced from the window.

In certain embodiments of the present disclosure or in certain environments or to save space, the physical components of the system will need to be physically adjacent to the interior of a window such a building window, a bus stop display window, or a stand-alone display window. In these embodiments, system components are mounted into the support device(s) or cradle(s) and those support device(s) or cradle(s) are physically mounted on the window. For example, one embodiment of the system includes: (a) the local computer; (b) the street traffic camera(s); (c) the store traffic camera(s); (d) the keyboard camera(s); (e) the display device(s) such a monitor display and a laser display; (f) the speaker; (g) the microphone; and (i) one or more supporting devices or cradles configured to hold either one or a combination of multiple of the physical components adjacent to the window.

It should be thus be appreciated that the present disclosure contemplates that multiple component supporters or cradles of the same or different types may be used on the same window to support multiple physical components of the system.

It should further be appreciated that the present disclosure contemplates that each component supporter or cradle and each physical component of the system can be configured such that the physical component will be able to easily slide into and out of the component supporter or cradle.

It should further be appreciated that the present disclosure contemplates that the display device supporter(s) or cradle(s) that hold the display devices(s) will: (a) in various embodiments, support the display display(s) facing either towards the exterior (i.e., toward the window); (b) in other embodiments, support the display display(s) facing either towards the exterior or the interior, and having the ability to be switched between the two.

It should further be appreciated that the present disclosure contemplates that the display device supporter(s) or cradle(s) which are attached to the interior surface of the window will have a strong enough adhesion to the window that it will support the weight of the physical component.

It should further be appreciated that the present disclosure contemplates that the display device supporter(s) or cradle(s) will be removable from the window without causing any permanent damage to the window and without leaving any permanent adhesive or other residue on the window.

It should further be appreciated that the present disclosure contemplates that the display device supporter(s) or cradle(s) that can include one or more other mechanisms (not shown) that prevent theft of the system components.

It should further be appreciated that the present disclosure contemplates that in various embodiments the display device supporter(s) or cradle(s): (a) enhance the physical security of the physical components of the system by making them more difficult and time consuming to access; (b) enhance the aesthetic impact of the system component installation to people both on the interior and exterior sides of the window; and (c) assist in controlling the backlighting that surrounds the camera(s) to make the quality of the digital video images captured by the camera(s) more consistent and easily readable both to the human eye and to the algorithms processing the digital video data feeds.

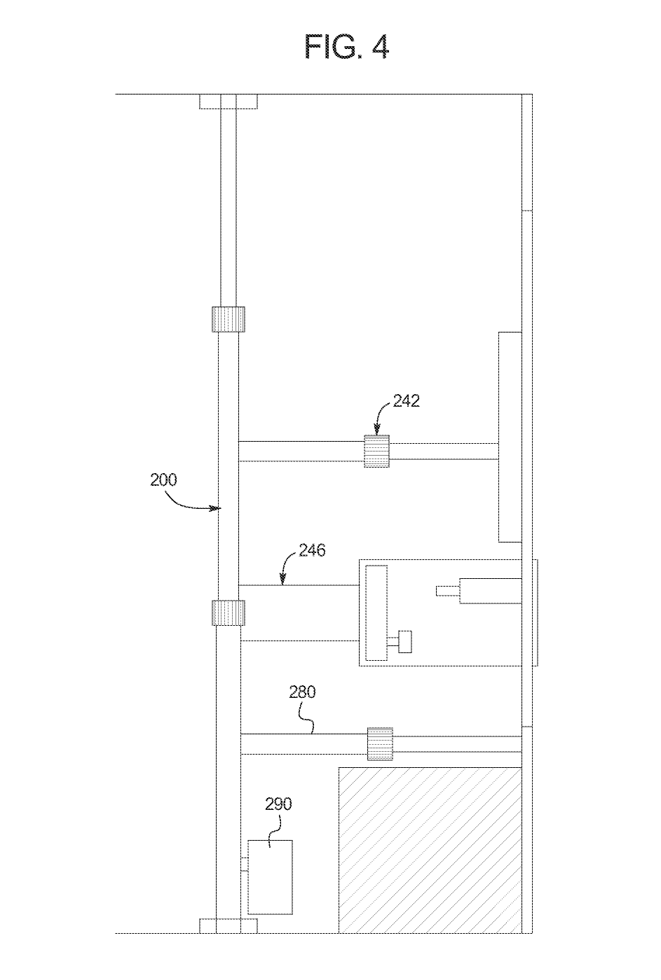

FIG. 4 generally illustrates an alternative embodiment for the supporters and cradles. This alternative embodiment includes a floor-to-ceiling support arm holder 200 (which includes an extendable pole) and a plurality of component supporters or cradles 242 and 246 for holding all the components of the system located at the store securely in place. In this illustrated embodiment, the pole 200 is extendable to accommodate ceilings of different heights. In various embodiments, the pole can be supported on the floor using a multi-legged base (such as a base having 3 or 4 legs) that are positioned either flat on the floor or at approximately a 45 degree angle to the floor. In various embodiments, the pole is also configured to be screwed into the actual floor at the points of contact between the pole (or the pole bases) and the floor. In various embodiments, the pole is configured to be affixed to the ceiling by being screwed into the actual ceiling at the points of contact between the pole (or the pole bases) and the ceiling. In another alternate embodiment, the pole is secured to the ceiling (with our without the screws on the ceiling) by adjusting the sections of the extendable pole and thus the pole length so that the force of the length of the pole wedges the pole into a secure position.

It should be appreciated that in addition to being installed against the floor of the store, the pole can also be installed onto the horizontal surface of the window ledge.

In this example embodiment, the pole is constructed from metal. In alternate embodiments, the pole can be constructed from other materials such as plastic (e.g. PVC) or combination of other materials such metal and plastic.

In one embodiment, each supporter arm is attached to the pole using a suitable locking mechanism (not shown) that enables the height of each supporter to be adjusted up or down. Each supporter can also be positioned at a suitable angle and length as desired to either side of the pole, as well as being positioned to be directly between the pole and the window. The length of each supporter and the angle with which it can be adjusted is flexible to enable a large number of components (such as multiple monitors) to be installed on a single pole.

Though not illustrated, it should be appreciated that there the present disclosure contemplates alternative embodiments that utilize various hybrids of elements both of the suction cup approach and the floor-to-ceiling approach. In one of these alternate, hybrid embodiments the bottom of the pole is affixed to the floor through one of the above-described mechanisms such as screws and/or a non-permanent base. The pole stands straight up at a 90 degree angle to the floor. The top of the pole does not reach all the way to the ceiling. Instead, a supporter is attached to the pole at a 90 degree angle at end of the supporter and then uses a suction cup (or multiple suction cups) to attach the pole to the window at the other end of the supporter. In another alternate hybrid embodiment, the bottom of the pole is affixed to the floor through one of the above-described mechanism such as screws and/or a base. The pole stands on an angle tilted towards the window at approximately a 70 degree angle to the floor. The top of the pole does not reach all the way to the ceiling. Instead, the display and pole is leaned against the window and uses a suction cup (or multiple suction cups) or other mechanisms of adhesion to attach the pole to the window at the other end of the supporter. In such cases, the suction cups are used to provide stability but are not burdened with carrying the entire weight of the display.

### Sensor Input: Accelerometer

In various embodiments of the system of the present disclosure, the local computer or other components of the system include one or more accelerometer sensors. The primary function of these sensors is to detect motion in the local computer for security purposes, in the event that an unauthorized person is removing the local computer.

### Sensor Input: Vibrations

In various embodiments of the system of the present disclosure, the local computer or other components of the system include one or more vibration sensors that are mounted against the interior of the window, likely in close proximity to the keyboard. The primary function of this sensor is to detect the discrete event of a user tapping on the glass.

### Physical Product Dispenser Devices

Although not shown, it should be appreciated that the present disclosure contemplates that separate devices could be connected to the local computer that enable an installation of the system to dispense a physical product sample to a user. For example, a beauty store could install a dispensing device on the exterior of the window that contains sample quantities of many different types of perfume that the store sells. The perfume dispenser device could be wirelessly connected to the local computer, and following the instructions of a perfume sample application, upon command dispense a small amount of a perfume that the user would be able to smell or apply. A similar type of dispenser could be installed for other product samples, such as pieces of candy or printed information brochures. It is anticipated that these samples could either be sold through the system or dispensed as a free marketing technique or customer courtesy.

### Printed Informational Signs

Although not shown, the present disclosure contemplates that one or more informational signs may be placed in proximity to the system to attract the attention of potential users and/or provide instructions to the users.

In one example embodiment, a printed sticker is affixed to the rear of a display device which informs the user that on the opposite side of the display device is a display and that the display is visible when standing on the opposite side of the window. An example of the printed final instruction reads, “The real action is on the other side of the window!”

In another example embodiment, the display device positioned against the window is surrounded on all sides by a series of peel-off stickers. Each sticker is formed or printed with an indicator such as a large arrow and affixed to the window so that every arrow is pointing to the display device. This could be used to attract possible users to the display device.

In another example embodiment, the present disclosure contemplates that a sign can be hung on the exterior of the window (such as at a 90 degree angle to the window). The sign is positioned just above the display and is formed or printed on both sides with an indicator (such as an arrow) that points towards the display device. This could be used to attract possible users to the display device.

### Alternative Combinations

It should be appreciated that the present disclosure contemplates many different combinations of the above described components and that different combinations may be better suited for different store environments or be more cost effective at different times due to pricing for the various technology components.

For example, in various embodiments, the system includes: (a) the processor and memory devices of a touch screen tablet computer functioning as the local computer; (b) the display that is built into a touch screen tablet computer; (c) a separate street traffic camera; (d) a keyboard camera; and (e) a frosted sticker keyboard.

In one alternate version of this embodiment that uses the tablet as the local computer and the function of the keyboard camera and/or street traffic is performed by a camera(s) built in to the tablet. In the event that the built-in tablet camera(s) is not properly positioned to provide this function (e.g., the keyboard camera in the tablet faces the interior of the store and not the window, or the keyboard camera in the tablet is positioned higher than the keyboard), in certain embodiments, a mechanical periscope tube is utilized to provide the camera with the correct field of vision. This tube can be straight or have multiple segments that are connected, but on angels to each other. At each end of the camera and/or at each segment junction, a mirror can be placed on the tube. The mirrors are configured to transport the required image from the street or keyboard to the camera without creating image distortions that impede the algorithms in the user input software or street traffic processing software.

An alternate embodiment includes a separate camera processor board. In these embodiments, all of the components except the keyboard are mounted on or adjacent to the interior side of window inside of a single enclosed box and the keyboard is mounted on exterior surface of the window.

In other example embodiments, the system components include the local computer housed in a box together with a street traffic camera, a keyboard camera, and a camera processor board. An LED monitor serves as an external display attached to the local computer. One cradle is mounted to the interior surface of the window and supports the local computer, the street traffic camera, the keyboard camera, and the camera processor board. A separate cradle is mounted on the interior surface of the window and supports the LED monitor.

### General System Functionality

In various embodiments, the components of the system co-act to provide various different non-interactive and interactive functions for users. Both types of functionality are provided by the system through software applications that can utilize or are executable by different combinations of the hardware components described earlier in this document and the software and networking components such as the Application Programming Interfaces (APIs) that can access services (such as data and functionality) both on local and remote computers in the system as well as external services available on the Internet and Internet access described below. In various embodiments, the system includes a master controller software application which controls the interactions between the individual software applications and handles prioritization decisions (such as determining when the displays will change from showing non-interactive advertising display to presenting the user with a list of applications that they can choose to launch).

### System Structure and Applications

As indicated above, the system of the present disclosure is configured to provide various different user functionality and user services through various different software applications. Various examples of these software applications are also discussed below; however, it should be appreciated that the system of the present disclosure is not limited to these example applications. Additionally, the system of the present disclosure provides Application Programming Interfaces (“APIs”) that can be accessed by one or more individual software applications built for the system. These APIs provide access to common functionality as well as existing data already stored by the system. These APIs are distinct from the software developer tools that are used to write, test and deploy the actual software code that serve as the technical basis for both the APIs and the software applications that call these APIs.

In various embodiments, this system will also make this data made accessible to other external information systems via the APIs. For example, a store could have a customer relationship management (“CRM”) system or customer loyalty management system. The users of these systems would benefit from being able to access data about users (i.e., customers) and linking this to data about the same users (i.e., customers) that is already contained within their databases.

### Remote Computer

As mentioned above, in various embodiments, the system includes one or more remote or central computers (which each include hardware and software components) that are located in one or more back-end data centers remote from the systems (i.e., remote from the areas adjacent from the interior areas adjacent to the window). The functionality supported by the remote or central computer(s) extends the functionality available to the local computers by providing access to additional computer processing, additional data storage, connectivity to data and functionality available outside of the system on the Internet. The remote computers also provide the ability to provide functionality that takes advantage of multiple local computers sharing data with each other. In various embodiments, the remote or central computer(s) and the local computer(s) use Internet communications protocols and Internet connections to communicate with each other.

In various embodiments, the system uses cloud-based servers which are implemented in any suitable configuration such as: (a) a cloud solution hosted and operated by the provider of the system components; and (b) a copy of the remote or central computer software operated in a private cloud by another organization.

### System Software and Content Store

In various embodiments, while the local computer will be provided to the stores pre-loaded with certain applications, the administrator of the system or local computer will be able to access an online store that sells applications specifically configured to work with the system. In this document, the administrator refers to the individual or individuals who install and manage a specific instance or installation of a local computer installed at a specific window on behalf of the organization that is responsible for that window. The system will enable the administrator to also be able to purchase content such as music files and graphics or photographs that can be used within existing applications such as an ambient music application. The applications and content available for sale in the store can be built and uploaded by third parties who will receive revenue from the sale of the digital assets that they have created. In various embodiments, using a browser interface or a custom application interface, administrators of local computers will be able to search, browse, purchase (or license) and download new applications and updated versions of existing applications that have been specifically configured for use with the system.

In one embodiment, the store will also enable the administrator to download updated versions of applications that have already been downloaded, as well as firmware updates for the processor boards on the local computer.

In one embodiment, the online store content and applications is purpose-built for providing digital assets for the local computers. In another embodiment, the local computer is also configured to access a software store that also supports other types of devices. Examples of this embodiment include Apple's iTunes store for iOS devices, Google's Google Play store for Android devices and Amazon's Appstore for Android devices.

### Remote Computer Database

In various embodiments, the system includes one or more databases located on the remote computer(s). In various embodiments, these databases are accessible for reading and writing of data by the applications and APIs on the local computer through direct database queries and APIs located on the remote computer. The remote databases enable data (such as user account information and user behavior information) to be aggregated across all local computers, regardless of their locals and the organizations that own them. In various embodiments, once this data has been aggregated across local computers, the full aggregated database will be available to each local computer, thereby enhancing the functionality available to each local computer.

### Store Products and Services

In various embodiments, the system includes one or more applications and one or more databases located on the local or remote computers that cause the display devices to display advertisements and other information regarding the store and the store products or services. In various embodiments, the system also includes one or more applications and one or more databases located on the local or remote computers that cause the display devices to enable the users to interact with the system to see store information, products, and services, and to obtain more information about the store products and services (even when the store is closed). For example, in one embodiment at a restaurant the system enables a user to explore a multimedia application (such as having photos, text, videos, and audios) that illustrate every menu item available at the restaurant, how the items is prepared, any special dietary information about the item, information about the culinary history of the item and the cost of the item. In various embodiments, the system further includes one or more applications and one or more databases located on the local or remote computers that cause the display devices to display or provide one or more general or specific enticements or offers to cause the users to enter the store. In one example embodiment of this, a store will be able to advertise a discount on a specific product or service during a specific time period. These offers can be controlled by the administrator of the local computer, so that the offers can be rapidly created, modified and removed.

### User Registration and Authentication Services

As indicated above, it should be appreciated that the system has a set of general functionality, applications, and content that work in a default mode. Default mode will operate with the same settings the same regardless of the window and type of setting in which the system is installed. A first level of functionality, applications, and content can be implemented for a specific instance of the system configuring the system for a particular type of establishment (such as restaurant, retail bank or clothing store), as well as the geographic coordinates of the installed system. A second level of functionality, applications, and content can be implemented when the street traffic camera detects a particular type of person walking past the window (such as a person pushing a stroller or a person walking a dog) where the system is installed. In an alternate embodiment, the second level of functionality, applications, and content can be implemented when the user mobile device detector detects a particular type of device being carried by someone walking past the window (such as a person carrying an iPhone or a mobile device that is specifically marketed to teenagers) where the system is installed. For example, this data can be used to deliver better personalized advertisements in a manner that has not been done before, or to conduct campaigns that target users across multiple installations of the system through the unique identification of their mobile device when they are in different locations.

A third level of functionality, applications, and content can be implemented when the street traffic camera detects a person and is able to match the person's face to a photograph of a person already in the system's user database. In an alternate embodiment, the third level of functionality, applications, and content can be implemented when the user mobile device detector detects a particular unique device that has been previously identified and recorded in the system's database. A fourth level of functionality, applications, and content will be implemented when a user authenticates with the system (with some form of a username and password) installed on the window through one of the authentication methods described later in this document. Each successive level of personalization will enable the system to provide functionality, applications, and content that is better tailored to the individual needs and desires of the user.

In various embodiments, the local computer will enable each user to register and then authenticate his/her identity with the system's user database(s). The system can use various different mechanisms for this authentication.

In one example embodiment, the system uses a keyboard-based login through the window using a system-specific User-ID (e.g., username or email address) and password that the user self-registers for using the system). Upon registering the first time, the system enables the user to provide their name, contact information including email address and cell phone number and select a user ID and password. This ID and password is used for subsequent logins at any system implementation.

In various embodiments, the local computer enables each user to have non-secure access to the system such as by requiring only a user name to be entered. In certain of these embodiments, the system limits the functionality available to the user.

In various embodiments, the local computer enables the user to use a third 3rd party User ID and password authentication mechanism. In these cases, the users have already signed up for this third party service before arriving at the installation of the system. Currently available third party authentication services include: (a) Facebook Connect; (b) Google; (c) Yahoo; and (d) LinkedIn.

In various embodiments, the system employs biometric type authentication through the window using: (a) facial recognition with the street traffic camera and/or store traffic camera; (b) fingerprint recognition where the user presses a finger, fingers or a whole hand (or hands) against the window using the sticker keyboard or street traffic camera; and/or (c) voice identification using the system microphone.

In various embodiments, the local computer will enable user authentication through communication with the user's mobile device (e.g., tablet or smart phone). In one embodiment, the user's mobile device communicates wirelessly through a local connection (such as WiFi, Bluetooth or NFC) with the local computer of the system. In another embodiment, the user's mobile device communicates over the Internet with the local computer of the system. In another embodiment, an app or website accessed on the user's mobile device will cause the user's mobile device to display a unique identifier (such as a QR code). The user can then hold the mobile device so that its display is visible to a camera attached to the local computer. The camera will then record a video or photograph of what is on the mobile device's display and transfer this to the remote or local system computer that can identify the unique identifier in the image and authenticate the user associated with that unique identifier.

### User Privacy Services

As mentioned above, the system of the present disclosure can implement various different suitable methods to ensure that any private user information is not visible or accessible to another person who is also near the window or the system.

In various embodiments, the system provides a secure logout for each user that clears the user's cache so that the next person who walks up to the window and the system will not be able to access the prior user's data. This is akin to a comprehensive logout and cache and downloaded documents clearing on a shared personal computer deployed in a hotel lobby.

In various embodiments, the street traffic camera monitors when a user walks away from the window or stops using the system. At such point, the system can cause an automatic logout process to occur to protect that user's privacy.

### User Identity Management Services

Various embodiments of the system will maintain a database of user identities which are received from several different sources of information. The first source is self-registrations on the systems. The second source is headshot photos of unique users or people on the street taken by the street traffic camera. The third source is headshot photos of unique users or people on the street taken by the store traffic camera. The fourth source is information collected from the users' mobile devices through Bluetooth or WiFi through the User Mobile Device Detector. The fifth source is user identities maintained by other information systems used by the store such as loyalty card systems and customer databases.

In various embodiments, the system user identity management functionality merges these profiles at one or more points in time. For example, if a user whose identity is only known through a headshot can later be matched with an existing user in the system's customer database, these identities are joined together and all of the related data that has been collected about these identities are also joined together. In another example, a user could pass by a store window where the system is installed multiple times and the system will record the presence of the user's device. However, once the user registers for an account on the system, the user's mobile device can then be linked in the database to the other information maintained about the user such as email address and Facebook account.

### User Profiling and Personalization Services

In various embodiments, the system will gather detailed data profiles on users from a combination of sources such as but not limited to: (a) data provided directly by users through the system (such as contact information and family demographics); (b) data provided as a byproduct of users interactions with the system (such as tracking user clicks and selections in the system); (c) data gathered by system applications about the users due to their physical proximity to the system (such as monitoring user movements through a street traffic camera and or user mobile device detectors); (d) data about the users provided by the owners or operator of the system implementers (such as purchase history data from a point-of-sale system or a customer relationship management system); and (e) third party data about the users that are linked to user profiles (such as data provided by a data broker such as Google or TransUnion).

In various embodiments, this system makes this data available via the API to enable a personalization of the user experience, including applications, content (e.g., advertising), user interface customizations and special retail offers. For example, in one embodiment there could an API call designed to answer the question, “Does the system already know if this user has children under the age of 10?” This answer could then be used to drive a personalized advertising experience for the user.

### User Measurement Services

In various embodiments, the system gathers detailed customer (or potential customer) data using the street traffic camera(s) and/or the user mobile device detectors to monitor user actions on the street and the store traffic camera(s) to monitor the interior of the store including but not limited to: (a) people passing by a store; (b) people stopping to look through a store window or storefront display; (c) people stopping to interact with a system; (d) people entering a store; (e) people browsing products in a store; (f) people looking at a menu or list of products or services in a store; (g) people making a purchase in a store; (h) people making a reservation or similar activities; and (i) people leaving a store.

### A/B Testing Services

In various embodiments, the APIs will support the deployment of NB versions of content, data, user interfaces and applications both within a single system implementation and across multiple system implementations to support validated learning about user preferences. In one example embodiment, a store that specializes in selling country music CDs uses the local computer and its speaker to project audio to the street of samples of the music that the store sells. The store wishes to gain a better understanding of which types of music and what volumes of this music are most likely to attract someone to enter the store. Using the A/B Testing Services API, the store designs a number of tests with playing different music selections at different volumes at designated dates/times. After the tests are completed, the store can analyze the user measurement data (as well as other data external to system such as in-store sales data) against the data about which music was played at which volumes at different times. The system will enable the store to determine if any of the tests induced more users to enter the store and/or make purchases in the store.

In another example embodiment, the system enables the store to create multiple versions of the user interface for an application that enables users to sign up for an email list for the store. Using the NB Testing Services API, the system can alternate which of these users interface versions are shown to each user and track which interfaces are most likely to induce the user to sign up for the email list.

In another example embodiment, the system alternates various states of interactivity and display including appearing to be turned off, in order to create a baseline and comparisons for quantitatively assessing the effectiveness of the system to the store owner or operator or landlord. This can be tested at different times of the day, different days of the week, different seasons, different weather conditions and in temporal proximity to different special events such as holidays and major sporting events.

### Event Detection Services

In various embodiments, the system operates an event detection service in the background that monitors for specific occurrences of designated events.

For example, any event that is identified by the system's street traffic application (which is described below) can be made available through this service as an event which can trigger an action in another application. One example of this is if the street traffic application detects a person walking who is pushing a stroller, an event can be triggered in the event detection services which notifies the advertising application to display an ad targeted at a parent with young children. In another example, if a specific MAC address for a mobile device that is recorded as passing by the system at a specific time range (e.g., 8 to 9 AM every morning, Monday through Friday), an event can be triggered whenever that MAC address is detected by the user mobile device detector that creates an advertisement for the user for a morning coffee at a nearby coffee shop.

In another example, an event is detected by the keyboard camera application that the sticker keyboard is being removed from the window. This event can then be passed to a keyboard security application that will notify the store of the event, and or broadcast an audio message on the speaker.

In another example, an event is detected by the vibration sensor application that the window has been tapped on three times in rapid succession. This event can then notify the local computer that a user is ready to use the application and that it should change what is displayed on the screen to be something of interest to a new user.

### Screen Control Services

In various embodiments, the system includes a screen control system that determines what is shown on the displays when the system is not being actively utilized. These services include a business rules engine that enables the administrator to prioritize what is displayed on the screen as a default at different points in time (e.g., advertisements, lists of available applications, etc.). These services will also interact with the event detection services that operate in the background, so that a specific business rule can be executed if the system detects a predetermined event (e.g., the street traffic application detects a person walks by the street traffic camera pushing a stroller.) In certain embodiments, the business rules will take into account the presence of multiple people in simultaneous proximity to the window or system for additional personalization business rules. The user interface represented in the displays can be customized based on different dimensions of data including the store level, at the user level for individual users or for groups of users with common attributes.

### Social Network Integration Services

In various embodiments, the system supports integration with third party services available on existing social networks such as Facebook, Foursquare, Instagram, Twitter, and Google+. In various embodiments, the system enables the user to perform one or more of any of the following functions using the system: (a) location-based check-ins where the system enables the user to post that they are at a specific store/location using a social check-in services such as Foursquare, Facebook Places and Google Latitude; (b) like/follow updates where the system enables the user to affiliate his/her social networking profile with a profile owned by the same organization that owns or operates the system; (c) status updates where the system enables the user to post a status update to a social networking service (e.g., write a tweet or update his/her Facebook status); and (d) content sharing where the system enables the user to share a piece of content they see using the system with another user(s) through a social networking service (e.g., sharing a photo of himself/herself taken with system photo booth application using Instagram or Facebook) or through email.

### Video, Photo and Audio Feed Services

In various embodiments, the system makes the digital video and digital photo feeds from the system cameras and the audio feeds from the installation's microphones available in real-time through an API. These feeds can then be used by other applications on the local computer, on the remote computers or by applications operating externally to the system (such as customer relationship management applications). For example, the street traffic camera feed can be accessed through an API by an application that transmits this data to the remote computer where it is stored. This data can then be accessed by a separate application at a later date, enabling a remote user to view the video feed as a security camera recording.

### Communications/Telecommunications Bridge Services

In various embodiments, the system provides an API that enables applications on the local computer and remote computer to integrate external communications and telecommunications services such as telephone calls, email, and text messaging. The APIs, in turn, are connected to a telephone bridge service, an SMS service and an email service, enabling communication with people and devices outside of the system.

One example embodiment of this API is that a user places an order for carry out food using an app on a local computer installed a restaurant. The app for ordering food on the local computer later uses the API to text the user's mobile phone and/or email the user when the order is ready for pickup. Another example embodiment of this API is that a user is browsing residential property listings using an app on a local computer at a residential real estate brokerage office. When the user identifies a property where he wishes to speak to the listing agent, the user selects a “Call the Agent” option in the app. Using the API, the system then places a phone call to the real estate agent's telephone, and the user is able to speak through the local computer's microphone and listen through the system's speaker.

### System Software Applications

In various embodiments, the system software applications are installed on the local computers or are dynamically downloaded from an application store to the local computers. These applications, when executed, enable the system to provide various services and functionality to users of the system. In various embodiments, the system includes server-side components to these applications installed on the remote or central computers. It is anticipated that many of the applications will utilize one or more of the services available on the local and remote computers to access common functionality and data, such as the services described earlier in this document.

In various embodiments, these applications are preloaded on the local computer before delivery of the system to the operator. Additionally, other applications can be installed through the system software store.

The following sections provide example applications available through the system and particularly the local computer. Due to the open and flexible nature of the system, it is anticipated that operators, implementers, customers, users, and other third parties will develop many additional ideas and customizations for applications.

### Local Computer Administrator Application

In various embodiments, the system includes an administrator application which enables an authorized administrator of a local computer to perform administrative functions. One example of an administrative function is registering the local computer with the remote computers when the local computer is first being set up. Another example of an administrative function is adding a new application to the local computer that has been selected, purchased and downloaded through the system software and content store. In another example, the administrator can select, purchase and download a MP3 music file through the system software and content store, and configure an Ambient Music Application to add this song to its rotating playlist to be played through the local computer's speaker. In another example, the administrator can enter the store's operating hours for each day of the week into a store information application, so that these hours can be made available to applications on the local computer that need to vary their functionality based on this information. For example, an application for a coffee shop that enables a user to place a carry out order should not allow an order for coffee to be placed at a time when the store is not open to fulfill it.

The administrator will also be able to configure the local computer to automatically send notices (e.g., SMS, email) in the event that the local computer detects a problem with its operations. For example, the local computer could detect an event where a device attached to the local computer (such as the keyboard camera) has lost its connection to the local computer. This event will notify the local computer administration application which can in turn be configured to notify the administrator via email or SMS text that there is a problem with the keyboard camera.

### Street Traffic Application

In various embodiments, the system includes a street traffic application which includes open source algorithms that receive the unstructured digital photo and digital video data captured by the street traffic camera (or multiple cameras that together provide a broader field of vision) and derive structured data from them related to activity in the camera's field of view related to pedestrian, vehicle, bicycle traffic. This data would be correlated with a date and time stamp that will be tied to specific frames of video, segments of audio or the exact time a still photo was captured. In various embodiments, the system can also receive data from the user mobile device detector to replace or further augment the data from the camera(s). The combination of these sets of data with the interactivity of the system creates new and unique value for both the store owners and the end users.

More specifically, in various embodiments, the street traffic application performs one or more functions for pedestrian related data such as but not limited to: (a) determining each time a pedestrian passes by the street traffic camera; (b) determining if the pedestrian is pushing a stroller; (c) determining if the pedestrian is walking a dog; (d) determining if the pedestrian is walking as part of a larger group of pedestrians; (e) determining each time a pedestrian stops in front of the street traffic camera, how long that person remains in front of the street traffic camera and if this person interacts with the system; (f) determining each time a pedestrian enters the store; (g) determining each time a pedestrian exists the store; (h) isolating a headshot photo of each pedestrian; and (i) deriving basic characteristics of each pedestrian such as height, age, and gender.

In various embodiments, the street traffic application performs one or more functions for vehicle (such as automobile) related data such as: (a) determining each time an vehicle passes by the Street Traffic Camera; (b) determining the direction and speed of the vehicle and if there are delays in vehicle traffic (e.g., due to traffic congestion or road construction); and (c) determining the type of vehicle.

In various embodiments, the street traffic application performs one or more functions for bicycle related data such as: (a) determining each time a bicycle passes by the street traffic camera; (b) determining the direction and speed of the bicycle; and (c) deriving basic characteristics of the person riding the bicycle including height, age and gender.

The data output by the Street Traffic Application will be stored in the system's database(s) both locally and on the remote computers/databases. This data will be accessible through an API. It should b appreciated that there are multiple possible applications and users for this data. In one embodiment, stores will be able to access their own local computer's street traffic data through the API. In another embodiment, data aggregated across multiple local computers in multiple stores is monetized by licensing the data to third parties (such as organizations that provide real-time street traffic congestion updates online and in GPS devices, and local governments interested in better understanding the volumes and times of local street and sidewalk utilization.)

### Store Traffic Application

In various embodiments, the system includes a store traffic application which includes algorithms that take the unstructured digital photo and digital video data captured by the store traffic cameras and derives structured data from them related to activity in the camera's field of view related to activity within the store. In various embodiments, the system can also receive data from the user mobile device detector to replace or further augment the data from the camera(s). The combination of these sets of data with the interactivity of the system creates new and unique value for both the store owners and the end users.

More specifically, in various embodiments, the store traffic application performs functions such as: (a) determining each time a pedestrian enters the store; (b) determining each time a pedestrian exits the store; (c) isolating a headshot photo of each pedestrian; (d) deriving basic characteristics of each pedestrian including height, age, and gender; and (e) identifying data about the user's mobile device such as manufacturer and type of device.

By monitoring the movements of each pedestrian in the store, the store traffic application determines when the pedestrian in the store is performing activities such as: (a) browsing products; (b) using a changing room; (c) purchasing a product; and (d) conducting other activities such as sitting down. In various embodiments, the store traffic application also tracks facial expressions to infer specific emotions.

The data output by the store traffic application will be stored in the system's database(s) both locally and on the remote computers/databases. This data will be accessible through an API. It should be appreciated that there are multiple possible applications and users for this data. In various embodiments, the system will enables the stores to access their own local computer's street traffic data through the API. In other embodiments, the system enables data aggregated across multiple local computers in multiple stores to be monetized by licensing the data to third parties (such as organizations that provide national estimates on retail shopping data trends.)

### Security Camera Capture Application

In various embodiments, the cameras connected to or which communicate with the local computer capture digital videos and digital photos of either or both of the interior areas or exterior areas and the system uses this data for security purposes. The system sends this data to one of the remote computers for storage and later viewing or analysis using security camera viewing applications that may or may not be a part of the system.

In various embodiments, the system enables the local computer administrator to configure this application to utilize a motion detector feature, such that the system notifies the administrator in the event that the application detects motion either in certain time windows and/or in certain portions of the field of view.

### Empty Building Space Feedback Application

In various embodiments, for empty building spaces, the system enables users to vote and to provide comments on the kind of establishment that they would like to see fill the space. The system also provides contact information for the building's broker and/or enables the user to register if they wish to receive relevant updates about changes in the status of the building. It should thus be appreciated that landlords and brokers will then be able to use this data together with the data compiled by the street traffic application to help secure leases with stores for this empty building space.

In various embodiments, the system enables users to request to see different layouts for the empty building space, or to see additional photographs and or videos showing further information about the interior of the space.

### News Content

In various embodiments, the system provide users with third party news content (including financial markets, lottery announcements, sports news and weather content), which can be personalized to the geographic location of the local computer, as well as to store-specific and user-specific profiling data. This system can deliver multiple types of content including video, short form text, long form text, photos, multimedia and interactive content. For example, a local computer at a store in a neighborhood on the north side of Chicago could be configured to show a combination of national news and Chicago news, with a heavier emphasis on Chicago sports teams or local neighborhood news.

### Internet Web Browsing

In various embodiments, the system enables users to browse the web using a browser application installed on the system. The system enables the administrator of the system to set limits on: (a) the length of time that a user can browse; (b) the amount of bandwidth that can be consumed; and (c) the types of specific content that can be accessed using the browser based on parameters such as the source of the content and the bandwidth requirements of the content.

### Audio and Video Calls

In various embodiments, the system enables users to make audio and/or audio/video phone calls using a native application or a third party application (such as Skype). This system utilizes the speaker and microphone attached to the local computer. The system can place restrictions on the types and length of phone calls (e.g., the application can be figured to function as only as direct dial to the store owner or the real estate broker responsible for renting the space out.)

### Browsing, Searching and Buying Products

In various embodiments, the system provides one or more of browsing for, searching for, buying, and paying for products and services from one or more designated sources.

In various embodiments, the system enables users to browse, search, order, and configure a product catalog containing extensive text, video, and photographic details in an interactive mode. This catalog can support both simple purchases, as well as complex purchases (such as a food order from a restaurant or buying a custom embroidered item from a store).

In various embodiments, the local computer utilizes data about the user from both the local and remote computers to customize the user experience to enhance the experience, reduce the burden on the user and increase revenue. For example, when a user walks up to a coffee shop, the system using the street traffic application identifies the user through a match to the headshot stored in the user's account. The system through the ordering application causes the speaker(s) to ask the user if the user wants the same order that was placed last time. The user can use the system user input device to affirmatively answer, which results in the order being transmitted to the inside of the store and the user's credit card being automatically charged. The speaker then announces when it receives a message that the user's order is ready.

In various embodiments, the system facilitates payment in one or a plurality of different methods.

In various embodiments, the payment information is stored in the remote or central computer database.

In various embodiments, the system enables subsequent payment through a non-system mechanism (e.g., store POS system.)

In various embodiments, the system enables payment through an ongoing subscription.

In various embodiments, the system receives payments through suitable methods such as credit cards, debit cards, electronic checking account deduction, Paypay, Dwolla, Square, and NFC-based payment solutions.

In various embodiments, the system obtains the user's payment by: (a) NFC from the user's smart phone; or (b) taking a photograph of the front and back sides of the credit card using the street traffic camera and then processing this information using OCR technologies. In an alternate embodiment, the system also then captures a signature that the user provides writing with a finger on the mouse pad.

In various embodiments, the system supports ordering cross-store so that one store can use its geographic location to help fulfill physical functions for other businesses that do not have that same location. One example of this is having your dry cleaning available for pickup at your corner 24 hour convenience store, and arranging this through the local computer at either store. Another example is a clothing store that enables users to shop on the local computer for housewares sold by a different store.

### Queuing Up/Reservations

In various embodiments, the system enables users to make a reservation for a specific time with specific requirements (such as a massage appointment) and/or take a spot in a queue (such as taking a number to get in line at the grocery store butcher or requesting the next available table for four people). In various embodiments, the system sends notifications to people when their product/service/table is ready (or provides interim status updates) through the systems own interfaces, text message, email, direct message in social media, or other similar methods. In an alternate embodiment the system announced queue updates using audio messages broadcast through the local computer's speaker.

### Sign up for Specials, Sweepstakes, Mailing lists, etc. . . .

In various embodiments, the system enables users to provide their own contact and demographic profiling information for future use by the system, the organization hosting the system, or other organizations. In various embodiments, this enables the system to enable users to sign up for specials, sweepstakes, mailing lists, and similar marketing techniques by providing the local computer with contact information and permission to be contacted.

### Installation-Specific Content Display

In various embodiments, the system notifies potential customers that a particular store is open or closed, as well as the specific hours of business for the store.

In various embodiments, the system notifies users about store specials and sales, community event information, or the availability of specific products and services.

### Advertising Application

In various embodiments, the remote or central computer sends third party advertising content to the various system (or local computers of the systems) for display by the display devices. With this advertising network, the operators of these systems can be paid by third parties to enable the display of these advertising content for specified periods of time.

Since various embodiments of the system maintain user identity and profiling data and street traffic data, on the remote or central computers, the system can be used to provide personalized advertising campaigns that target a single user or groups of users at locations of the system and thus through different windows. These advertising campaigns enable the system to target specific users or groups of users at a specific local computer both in situations where they have authenticated with that specific, as well as in situations where the local computer is able to proactively identify the user via a headshot taken by a street traffic camera or other mechanism.

### Survey Application

In various embodiments, the remote or central computer sends third party survey content to the various systems (or local computers of the systems) for display by the display devices. With such a system, 3^{rd} parties can easily do in field market research with customers at the retail location. With this survey network, the operators of these systems can be paid by third parties to enable the display of surveys that can be completed by system users. Surveys could also be authored by the administrators of the local computers for use on those computers. Since various embodiments of the system maintain user identity and profiling data and street traffic data, on the remote or central computers, the system can be used to provide personalized survey data collection campaigns that target a single user or groups of users at locations of the system and thus through different windows. These survey campaigns enable the system to target specific users or groups of users at a specific local computer both in situations where they have authenticated with that specific, as well as in situations where the local computer is able to proactively identify the user via a headshot taken by a street traffic camera or other mechanism. In addition to the survey responses, the system can also link this to user profiling data obtained from the local computer, the remote or central computer and from information collected from the street traffic camera and processed by algorithms on the system.

### Attention Grabbing Application

In various embodiments, the system includes one or more people attention grabbing applications. When alerted by the event detection API to the fact that a pedestrian has come within the vicinity of the system, the system uses a display device and/or a speaker to project a message that will induce the user to approach the window and the system and begin to interact with the system. It should be appreciated that the audio and/or video message delivered by this application could be generic to all system installations, specific to this specific installation, or specific to any data available about the pedestrian identified by the street traffic application. For example, a specific audio and visual message could be developed for someone walking by the store who is pushing a stroller.

### Entertainment

In various embodiments, the local computer includes one or more applications that provide entertainment to the users. In various embodiments, these applications can be free or require the users to pay to be used. In various embodiments these applications are either stand-alone, communicate with the remote computer(s) or communicate with other local computers through the remote computer(s).

For example, in various embodiments, the system includes a photo booth application that enables users to take photos of themselves using one of the cameras attached to the local computer. Users will then be able to manipulate the photos (e.g., insert different backgrounds/themes or brand the photo with the store's identity). The system then enables user to share the photos online using the social network integration services and/or the communications/telecommunications bridge services described above. To give an example of this, two people approach a storefront which has the system and select the photo booth application to launch. They then press a soft button on the keyboard sticker which causes the system to take a photograph of them. They then select the photograph to be changed to black and white, and select the options to display the date, time and location of the local computer on the bottom of the photo in a small font. Finally, the users post the photo to their Facebook wall through the photo booth application of the system. In an alternate embodiment, the system enables the users to order printed copies of the photos through a photo printing commerce application. For example, a user could utilize the application of the system to transfer the photo to the closest drug store to be immediately printed.

In various embodiments, the system includes one or more game applications that enable user to play videogames on the system. Examples of videogames include board games such as checkers, card games such as poker or blackjack, interactive action games and fantasy role playing games. These games can also involve activities that cross different system installations. One example embodiment is a user earning a badge for checking into five different restaurants on a block which each have a local computer for the system. Another example embodiment is a multi-player game where multiple users of the system located at different local computers at different store windows play against each other in real time on a game that is coordinated across the local computers on a remote computer.

In various embodiments, the system includes one or more entertainment applications that provide a music jukebox that enables the music to either be selected by the user from a database of songs or to be personalized based on the system's user measurement data. In various embodiments, a wide range of features can be incorporated into these applications of the system such as gamification, social network integration, music recommendation services and commerce functionality that enables the user to purchase the music that they are hearing to be played on their own devices. For example, a user could authenticate to a local computer and request a specific song from a song database. The system could play the song, and then play a set of other songs which a recommendation service selects as being songs that the user might also like. The user will then share on their Facebook wall that they are listening to a specific song. Finally, the user will be given the option to purchase the song through an online music sales service such as iTunes or Amazon.com's MP3 download service.

In various alternate embodiments, the system includes one or more entertainment applications that provide a video jukebox that enables videos to either be selected by the user from a database of videos or to be personalized based on data in the system's database(s). In various embodiments, the functionality in the video jukebox application can be very similar to the functionality described above for an audio jukebox.

### Banking Applications

In various embodiments, the system includes one or more banking applications such as on a system at a retail bank branch, or at other types of window locations including retail stores on behalf of retail bank organizations.

The banking applications can, among other features, support the provision of interactive banking product information (such as mortgage rates), provide ATM functions such as depositing a check by taking a photo of the check using a system camera (which is a feature offered in many smartphone and tablet-based banking applications), checking bank balances, and transferring funds between accounts.

In one example embodiment, a retail bank could pay several area merchants to install their banking application on the merchants' local computers/retail windows. This would enable the retail bank to quickly expand to support many “virtual” ATM-type machines that involve no maintenance of physical, proprietary, single-purpose ATM devices.

### Integration with Local Commerce Services

In various embodiments, the system includes one or more applications that provide interaction with local commerce services such as Groupon, Living Social, OpenTable, and Belly. This enables the administrators of the system to offer users features such as real-time coupons, rewards points, or pre-paid offers. These offers can be personalized through the user and store level data maintained by the system and/or using the data from the third party local commerce service. For example, an application of the system could utilize user profiling data to offer users offers for immediate discounts that are at retailers in close walking distance to the user's current location.

### Local Computer Security Alarm

In various embodiments, the system includes one or more applications configured to prevent someone from stealing the local computer. These applications have an activation/deactivation feature that enables the administrator of the local computer to enable and disable the alarm system. When the alarm system is enabled, the local computer detects the potential theft of some or all of the system component through various methods such as but not limited to: (a) the accelerometer attached to the local computer (or other components of the system sense that they are being moved; (b) the local computer sensing a disconnection from any connected device; and (c) an attached circuit in the component holder or cradle detecting motion or a break in the connection between the cradle and the window or base stand.

Similarly, in various embodiments, the system software that processes the video feed from the keyboard camera will be able to detect if someone is removing the keyboard installed on the outside.

In various embodiments, if one of these events occurs to the system or local computer on the inside or the sticker on the outside, the system activates one or multiple alerts including producing a predefined audio message using the speaker that will be heard by the person touching the local computer or keyboard. The system can continue to play this audio until an administrator deactivates the feature. The security alarm can also be configured to send notification messages directly to the remote or central computer or to the administrator of the system using the communications or telecommunications bridge services.

Additional security features are provided by the street traffic and store traffic cameras, which are recording video that can include the face, body and actions of the person trying to move the hardware component.

### Mobile Device Solutions

In various embodiments, the system includes one or more mobile applications for various versions of the iOS, Android, Blackberry and Microsoft mobile operating systems that are configured to be run on the users' own mobile devices. These embodiments enable the system, in tandem with the user's mobile device, to create a bridge experience between the user's experience on the street, the inside of the store and the online world. In addition, in various embodiments, the same functionality is provided through a HTML-based, mobile-friendly website that can be accessed by the user on a browser application on the user's mobile device. The mobile device solutions described in this paragraph will enable to user's mobile device and the system to authenticate each other so that the system is aware of the user's identity and the user's mobile device is aware of the proximate system installed on a window. Once the authentication has successfully occurred, the user's mobile device can become a user input device for the system. For example, a user could launch a mobile application on an iPhone and then authenticate the mobile application and the system on the nearby window to each other. Once the devices have authenticated to each other, the user can then type of the keyboard of the iPhone (now a user input device) and the keyboard inputs of the iPhone are transmitted to the application on the system that communicates with the user's device (the user input detector and user input software). This embodiment of user input can function as an alternative to the other embodiments discussed in this document (such as the sticker keyboard and keyboard camera) or can be used in the same embodiment as other user input mechanisms (such as in combination with the sticker keyboard and keyboard camera).

These mobile applications enable the users to authenticate with a specific system installation and subsequently communicate for specific functions with the application. These functions include, but are not limited to: (a) using the motion sensors in the mobile device as a mouse/cursor controller for actions on or inputs into the system; (b) using the keyboard of the mobile device as the user input device for the system, so that whatever the user enters on their mobile device keyboard is processed by the system as if it was the point of entry; and (c) transmitting information such as photographs and event appointments between the system and the mobile device.

In various embodiments, the system includes one or more methods (or combinations of those methods) to conduct this authentication between the user's mobile device and the local computer.

One example method includes causing the speakers to emit specific audio signature that can be recognized by another device with a microphone, even if the audio signal is inaudible to humans. This enables a mobile device to identify which specific local computer it is interacting with. This approach is discussed in more detail earlier in this document and is also used by Shopkick in their mobile application.

Another example method includes providing a unique visual cue such as a QR code or a unique number which can be generated and displayed by either device, and identified by the camera on the other device. (This approach is used in LevelUp's mobile application.)

Another example method includes exchanging a specific authentication code between the user's device and the local computer using a local communication method such as Bluetooth or NFC.

### Mobile Device-Based Visual Input

In various embodiments, the system enables a user to use the user's own mobile device to interact with a system-related mobile website or system-related mobile application. The system enables the user to provide information to the local computer via the user's mobile device displaying a pre-determined set of structured visual information to be displayed on the screen of the user's mobile device. For example, the user can launch a mobile application related to the system on the user's tablet computer. The user then presses a button on this application in order to share the user's name, email address and cell phone number with the local computer. The application on the tablet computer then displays on the tablet's screen a unique QR code which embeds all of this information. The user holds the tablet's display proximate to and facing the window, directly in front of a camera attached to the local computer. The camera reads the visual information and specialized user input processing software then interprets the QR code and provides it as a command input for the system.

It should be appreciated that the same approach could also be used with other types of visual information and visual processing techniques, such as displaying text on the mobile display and processing that text on the local computer using optical character recognition techniques.

### Mobile Device Communication Through a Local/Direct Connection with the Local Computer

In various embodiments, the system enables a user to use a mobile device to access a system related mobile website or system-related mobile application. The mobile device transmits information between the mobile application and the system using a computer-to-computer communication mechanism such as Bluetooth or Near Field Communications (NFC) or Apple's Passbook.

### Mobile Device Communication Over the Internet with the Local Computer

In various embodiments, the system enables a user to use a mobile device to access a system related mobile website or system related mobile application. The mobile device transmits information between the mobile application and the system using the mobile device's wireless connection to the Internet and the local computer's connection to the Internet.

### Additional Applications

It should be appreciated that the system is configured such that additional functions can be added to the system at any suitable time. For example, additional applications (and updates to already installed applications) can be downloaded to the local computer to add functionality and to add to the range of different interactions between the system and the users. Likewise, additional applications (and updates to already installed applications) can be downloaded to the remote computer to add functionality and to add to the range of different interactions between the system and the users.

It should thus be appreciated that any number of software applications can be written and deployed on this system to support a very wide range of interactions with a user. These additional applications will facilitate stronger relationships between users passing the window and implementer of the system including retailers, non-retail organizations, and advertisers. These applications can utilize a unique combination of different assets to create a user experience that provides tremendous value for both the user and the implementer of the system. These applications can utilize a unique combination of different assets to create functionality, a user experience and data that provides tremendous value for both the users, the implementers of the system and others deploying applications on this system. These assets include: (a) a wide range of data input and data output devices that can be connected to the local computer; (b) a rich set of services and data made available through an API; (c) connectivity to a cloud-based remote computer and to the broader Internet; (d) the transformation an entire window into an interactive kiosk; (e) the proximity of the window to foot traffic and vehicle traffic on the adjacent streets; and (f) when applicable, the proximity of the window to an adjacent interior room.

### Alternative Embodiment

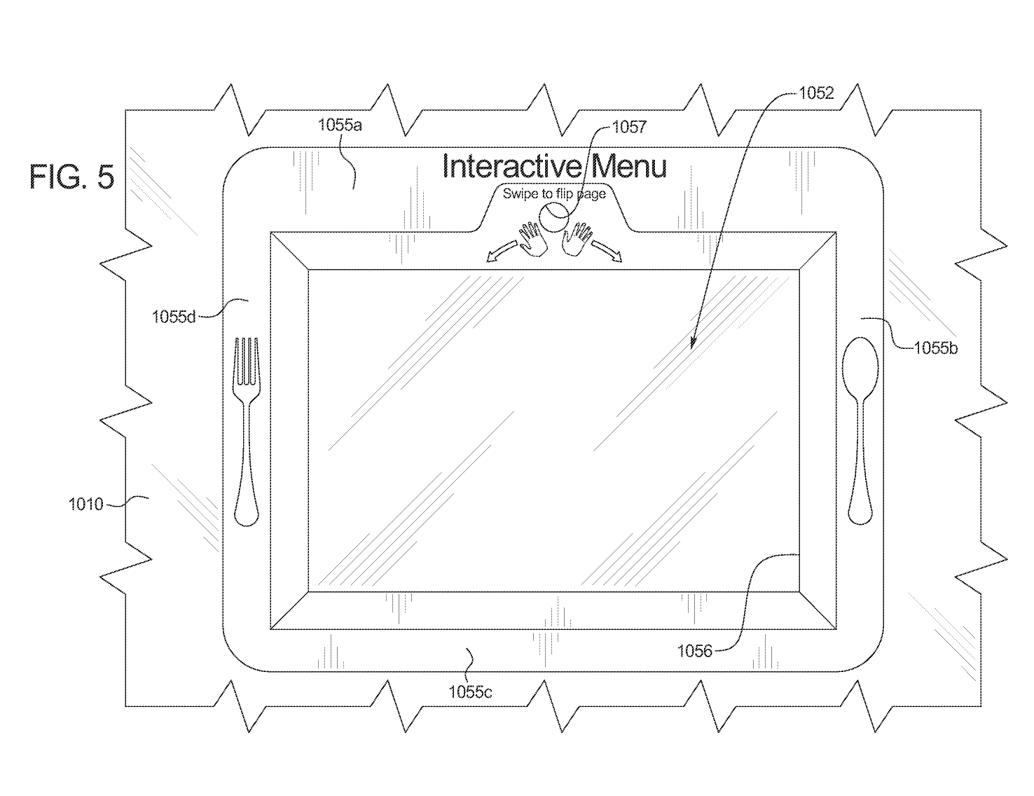

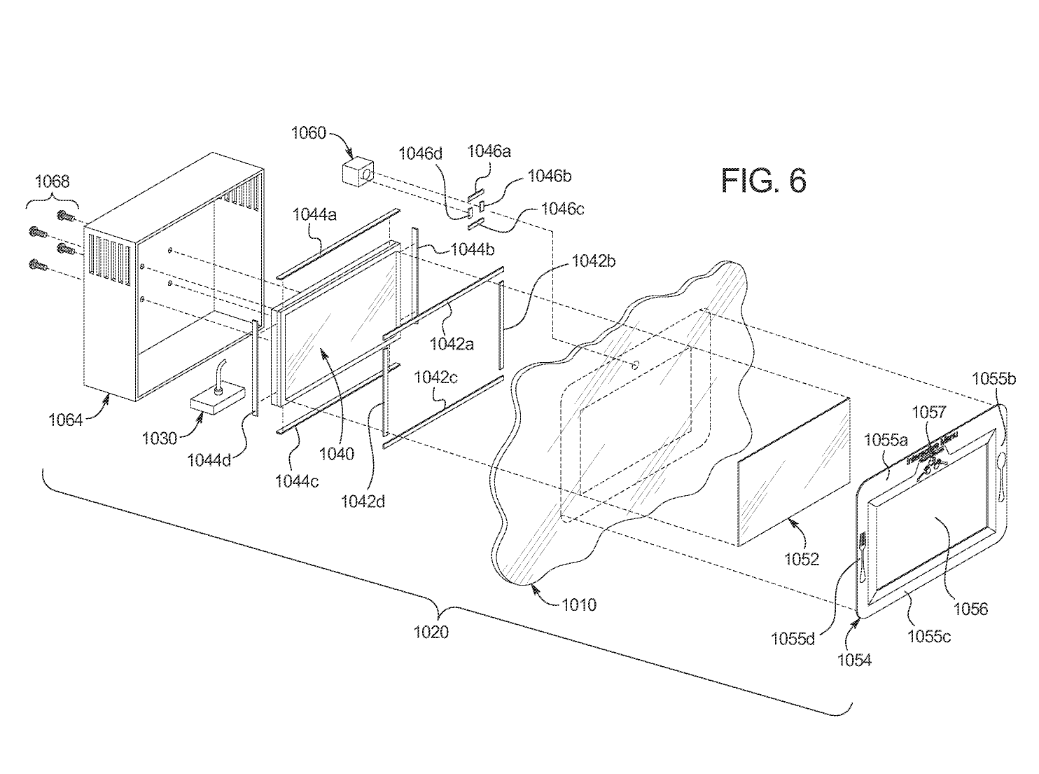

Referring now to FIGS. 5 and 6, another example embodiment of the computerized interactive display system of the present disclosure is partially illustrated and generally indicated by numeral 1020. This system 1020 is configured to function through the window 1010 and to be fully interactive with a person (not shown) standing on an exterior side of the window 1010.

More specifically, the system 1020 of this example embodiment includes a display device 1040 configured to be positioned adjacent to an interior surface of the window 1010 and controlled by a local computer 1030. In this example embodiment, the display device supporter 1042 includes a plurality of attachment strips 1042a, 1042b, 1042c, and 1042d of double sided tape configured to be attached to the front face of the display device and the interior surface of the window 1010 at desired or designated position on the window 1010. The attachment strips 1042a, 1042b, 1042c, and 1042d hold the display device 1040 adjacent to the window 1010 at the desired position. In one embodiment, the attachment strips 1042a, 1042b, 1042c, and 1042d are VHB double sided tape which is commercially available from 3M. It should be appreciated that prior to attaching the attachment strips 1042a, 1042b, 1042c, and 1042d to the window and the front of the display device, that a suitable cleaner such as an alcohol based cleaner is used to clean the interior surface of the window and the front of the display device to ensure proper adhesion. It should be appreciated that the attachment strips may be alternatively configured, sized, shaped, and positioned in accordance with the present disclosure. It should further be appreciated that other suitable tapes and other suitable attachment devices may be employed in accordance with the present disclosure to support the display device in a position adjacent to the interior surface of the window.

In this illustrated embodiment, the display device supporter further includes a plurality of support strips 1044a, 1044b, 1044c, and 1044d which are respectively attached to the side edges of the display device 1040. In certain display devices, the display devices are configured to be supported by the rear section, and the front panel is not meant to hold up the entire display device. For example, certain display devices include a rear cabinet section and a front panel (such as illustrated in FIG. 6). The support strips 1044a, 1044b, 1044c, and 1044d are employed to more securely attach the front panel to the rear section of the display device. In one embodiment, the support strips 1044a, 1044b, 1044c, and 1044d are also the VHB double sided tape which is commercially available from 3M. It should be appreciated that prior to attaching the support strips 1044a, 1044b, 1044c, and 1044d to the edges of the display device, a suitable cleaner such as an alcohol based cleaner is used to clean edges of the display device to ensure proper adhesion. It should be appreciated that other suitable support or securing mechanisms can be employed in accordance with the present disclosure.

The system 1020 of this illustrated embodiment includes a user input detector such as a digital camera 1060 configured to be positioned adjacent to the interior surface of the window 1010, configured to detect or capture and record user inputs, and configured to communicate with the local computer 1030. In this example embodiment, the user input detector supporter 1046 includes a plurality of attachment strips 1046a, 1046b, 1046c, and 1046d of double sided tape configured to be attached to the front face of the digital camera 1060 and the interior surface of the window 1010 at desired or designated position on the window 1010. The attachment strips 1046a, 1046b, 1046c, and 1046d hold the user input detector adjacent to the window 1010 at the desired position. In one embodiment, the attachment strips 1046a, 1046b, 1046c, and 1046d are VHB double sided tape which is commercially available from 3M. It should be appreciated that prior to attaching the attachment strips 1046a, 1046b, 1046c, and 1046d to the window 1010 and the front of the digital camera 1060, a suitable cleaner such as an alcohol based cleaner is used to clean the interior surface of the window and the front of the digital camera to ensure proper adhesion. It should be appreciated that the attachment strips may be alternatively configured, sized, shaped, and positioned in accordance with the present disclosure. It should further be appreciated that other suitable tapes and other suitable attachment devices may be employed in accordance with the present disclosure to support the user input detector in a position adjacent to the interior surface of the window.

In this illustrated embodiment, the local computer 1030 is configured to be positioned in an interior space behind the display device 1040. The local computer 1030 is shown in FIG. 6 with a cord (shown in fragmentary) which is attachable to an input port (not shown) on the back of the display device 1040 to facilitate communication between the display device 1040 and the local computer 1030. In one embodiment, the local computer is a U2 Android Stick commercially available from Smallart. It should be appreciated that other configurations of the local computer may be employed in accordance with the present disclosure.

The system 1020 in this illustrated embodiment further includes a housing 1064 which is attachable to the back of the display device 1040. The housing 1064 includes multiple walls suitably attached to each other and configured to form a front open ended box. The housing 1064 is configured to protect the display device 1040 and the computer 1030, and to provide a more pleasing aesthetic look to the system from the inside of the storefront. In this illustrated embodiment, the housing 1064 is attached to the display device using a plurality of fasteners 1068. It should be appreciated that the present disclosure contemplates that the housing can be alternatively configured, sized, and shaped and coupled with the display device in other suitable manners.

The system 1020 in this illustrated embodiment further includes an anti-glare film 1052 attachable to the exterior surface of the window at the position corresponding to the position of the display device 1040. The anti-glare film 1052 better enables the user to see the images displayed by the display device in various different lighting conditions. The anti-glare film 1052 adheres itself to the exterior surface of the window. In one embodiment, the film removes glare and enhances image brightness and contrast levels, and is commercially available from Screen Solutions International. It should be appreciated that prior to attaching the film 1052 to the window, a suitable cleaner such as an alcohol based cleaner is used to clean the exterior surface of the window to ensure proper adhesion. It should also be appreciated that the film may be alternatively configured, sized, shaped, and positioned in accordance with the present disclosure

The system 1020 in this illustrated embodiment further includes a frame 1054 attachable to the exterior surface of the window at the position corresponding to the position of the film 1052 and the display device 1040. In this illustrated embodiment, the frame 1054 includes four integrally formed sections or walls 1055a, 1055b, 1055c, and 1055d which define a central opening 1056. In this embodiment, the central opening 1056 is slightly smaller than the size of the film 1052 such that when the frame 1054 is attached to the exterior surface of the window 1010, the frame 1054 and particularly the inner portions of the walls 1055a, 1055b, 1055c, and 1055d overlap the film 1052. In this illustrated embodiment, the frame 1054 and particularly wall 1055a defines an opening 1057 for the user input detector and specifically the digital camera 1060 which enables the digital camera to see through the window 1010 while being at least partially hidden from view by a person on the interior side of the window. The frame 1054 also functions in part to hide from view the display device 1040 and the display device supporter 1042 (as well as the other components of the system 1020. In one embodiment, the frame is made from a suitable single piece of vinyl material, however it should be appreciated that the frame can be made from other suitable materials in accordance with the present disclosure.

The frame 1054 can be attached to the exterior surface of the window in any suitable manner. In one embodiment, the vinyl material is provided with an adhesive backing which is used to attach the frame 1054 to the window. In another embodiment, the frame is attached to the exterior surface of the window by a plurality of attachment strips (not shown) of double sided tape. In one embodiment, the attachment strips are VHB double sided tape which is commercially available from 3M. It should be appreciated that prior to attaching the frame 1054 to the window 1010, a suitable cleaner such as an alcohol based cleaner is used to clean the exterior surface of the window to ensure proper adhesion. It should be appreciated that the attachment strips may be configured, sized, shaped, and positioned in various suitable manners in accordance with the present disclosure. It should further be appreciated that other suitable tapes and other suitable attachment devices may be employed in accordance with the present disclosure to attach the frame to the exterior surface of the window.

Although not shown, it should be appreciated that the system 1020 can include one or more of the other additional components identified above such as sound producing device. It should also be appreciated that the system 1020 can be configured to perform various combinations of the functions and user interactions identified above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A computerized interactive display system comprising:
(a) a local computer;
(b) a display device controllable by the local computer and configured to be positioned adjacent to an interior surface of a window;
(c) a user input detector positionable adjacent to an interior surface of the window, configured to capture user inputs made by a user on an exterior side of the window, and configured to communicate with the local computer; and
(d) at least one supporting device configured to hold the display device and the user input detector adjacent to the interior surface of the window.

2. The computerized interactive display system of claim 1, which includes a user input device mountable on an exterior surface of the window.

3. The computerized interactive display system of claim 2, wherein the user input device includes a keyboard attachable to the exterior surface of the window.

4. The computerized interactive display system of claim 1, which includes an audio production device mountable adjacent to the window and controllable by the local computer.

5. The computerized interactive display system of claim 4, wherein the audio production device includes at least one speaker.

6. The computerized interactive display system of claim 4, wherein the audio production device includes an ultrasound transducer configured to generate at least one ultrasound carrier wave.

7. The computerized interactive display system of claim 3, wherein the keyboard is attachable to the exterior surface of the window using an adhesive.

8. The computerized interactive display system of claim 3, wherein the keyboard is attachable to the exterior surface of the window using a vacuum based mechanism.

9. The computerized interactive display system of claim 8, wherein the vacuum based mechanism includes a plurality of plastic bubbles, each plastic bubble containing air that can be evacuated when the plastic bubble is pressed against the exterior surface of the window.

10. The computerized interactive display system of claim 1, which includes a microphone mountable adjacent to the window, and configured to collect user vocal information that can be interpreted by the local computer.

11. The computerized interactive display system of claim 1, wherein the user input detector includes at least one CCD camera.

12. The computerized interactive display system of claim 1, wherein the user input detector includes at least one discrete photo detector.

13. The computerized interactive display system of claim 3, wherein the user input detector includes a vibration detector configured to detect user inputs on the keyboard.

14. The computerized interactive display system of claim 13, which includes a card housing mountable on the external surface of the window, wherein the user input detector is configured to read credit card information from a card inserted into the card housing.

15. The computerized interactive display system of claim 3, wherein the keyboard includes a plurality of touchable discrete keys, each key configured to generate a visual effect when touched by the user, said visual effect detectable by the user input detector and processable by the local computer to determine which of said discrete keys is touched.

16. The computerized interactive display system of claim 15, wherein each visual effect is caused by the movement of the discrete key.

17. The computerized interactive display system of claim 14, wherein each visual effect is caused by variation of reflected light reaching the user input detector from the discrete key touched by the user.

18. The computerized interactive display system of claim 17, wherein the reflected light originates from a fluorescing compound embedded in the keyboard.

19. The computerized interactive display system of claim 1, wherein the at least one supporting device include at least one suction cup.

20. The computerized interactive display system of claim 1, wherein the at least one supporting device includes an adhesive tape.

21. The computerized interactive display system of claim 1, wherein the at least one supporting device includes a floor-to-ceiling support mountable adjacent to the internal surface of the window.

22. The computerized interactive display system of claim 1, wherein the local computer is configured to control multiple display devices chosen from a group consisting of: monitors, TVs, projectors, laser signs, and digital signs.

23. The computerized interactive display system of claim 1, wherein the local computer is configured to operate in a default mode.

24. The computerized interactive display system of claim 1, wherein the local computer is configured to provide a first level of functionality, applications, and content for a specific installation at a particular type of establishment.

25. The computerized interactive display system of claim 1, which includes a street traffic camera, and wherein the local computer is configured to provide a second level of functionality, applications, and content when the street traffic camera detects a particular type of person moving past the window.

26. The computerized interactive display system of claim 1, which includes a street traffic camera, and wherein the local computer is configured to provide a third level of functionality, applications, and content when the street traffic camera detects a person and the local computer is able to determine an identification of the person.

27. The computerized interactive display system of claim 1, which includes a mobile device detector, and wherein the local computer is configured to provide a third level of functionality, applications, and content when the mobile device detector detects an identified mobile device.

28. The computerized interactive display system of claim 1, wherein the local computer is configured to provide a fourth level of functionality, applications, and content when the user identifies the user.

29. The computerized interactive display system of claim 1, wherein the local computer is configured to communicate with a remote computer to enable the local computer to access data from another computerized interactive display system.

30. The computerized interactive display system of claim 1, which includes a street traffic camera configured to monitor when a user walks away from the window.

31. The computerized interactive display system of claim 30, wherein the local computer is configured to cause an automatic logout process to occur when the user walks away from the window.

32. The computerized interactive display system of claim 29, wherein the local computer is configured to receive, store, or transmit: (a) data provided directly by the user; (b) data provided as a byproduct of the user's interaction with the user input device; (c) data gathered about the user due to the user's physical proximity to the window; (d) data about the user provided by one of a system owner, a system operator, and a system implementer; and (e) third party data about the user linked to a user profile.

33. The computerized interactive display system of claim 31, wherein the local computer is configured to use said data to enable a personalization of a user experience for the user.

34. The computerized interactive display system of claim 1, wherein the local computer is configured to enable the user to input a type of store the user wants to see in a space behind the window.

35. The computerized interactive display system of claim 1, wherein the user input detector is gesture-based and includes a digital camera attachable to the interior surface of the window to interpret specific human motions and gestures as specific commands.
